(19) United States
(12) Patent Application Publication
(10) Pub. No.: US 2024/0236354 A1
(43) Pub. Date: Jul. 11, 2024

(54) CODING/DECODING METHOD, CODE STREAM, CODER, DECODER, AND STORAGE MEDIUM

(71) Applicant: GUANGDONG OPPO MOBILE TELECOMMUNICATIONS CORP., LTD., Dongguan (CN)

(72) Inventors: Fan WANG, Dongguan (CN); Zhihuang XIE, Dongguan (CN)

(21) Appl. No.: 18/618,027

(22) Filed: Mar. 27, 2024

Related U.S. Application Data
(63) Continuation of application No. PCT/CN2021/120913, filed on Sep. 27, 2021.

(51) Int. Cl. H04N 19/46; H04N 19/159; H04N 19/176

(52) U.S. Cl. CPC H04N 19/46; H04N 19/159; H04N 19/176

(57) ABSTRACT

Provided are a coding/decoding method, a coder, and a decoder. The method includes: parsing a code stream to determine first mode usage identification information of the current block; if the first mode usage identification information indicates that the current block uses a first intra-frame prediction mode, predicting the current block according to the first intra-frame prediction mode to determine a prediction block of the current block; if the first mode usage identification information indicates that the current block does not use the first intra-frame prediction mode, parsing the code stream to determine second mode usage identification information of the current block; and determining a target prediction mode of the current block according to the second mode usage identification information, and predicting the current block according to the target prediction mode to determine a prediction block of the current block.

### CROSS-REFERENCE TO RELATED APPLICATION

This application is a continuation of International Application No. PCT/CN2021/120913, filed on Sep. 27, 2021, and entitled “CODING/DECODING METHOD, CODE STREAM, CODER, DECODER, AND STORAGE MEDIUM”, the disclosure of which is incorporated herein by reference in its entirety.

### BACKGROUND

At present, the international video coding standard setting organization has established a research group of a coding mode1 surpassing H.266/Versatile Video Coding (VVC), and named the mode1 (i.e., a platform test software) as an Enhanced Compression Model (ECM). The ECM not only expands sizes of coding units with a specific resolution, but also integrates many intra prediction and inter prediction technologies.

In the related art, taking the intra prediction technology as an example, an existing ECM includes a Decoder side Intra Mode Derivation (DIMD) mode, a Template Matching Prediction (TMP) mode and the like. Although these modes are intra prediction technologies, they are not distinguished, which not only reduces compression efficiency during encoding and decoding, but also introduces redundant operations on software and hardware, resulting in poor encoding and decoding performance.

### SUMMARY

Embodiments of the disclosure relate to the technical field of video processing, and in particular to an encoding method, a decoding method, an encoder and a decoder.

Technical solutions of the embodiments of the disclosure may be implemented as follows.

According to a first aspect, an embodiment of the disclosure provides a decoding method, which is applied to a decoder and includes the following operations.

A bitstream is parsed to determine first mode usage identification information of a current block.

If the first mode usage identification information indicates that the current block uses a first intra prediction mode, the current block is predicted according to the first intra prediction mode to determine a prediction block of the current block.

If the first mode usage identification information indicates that the current block does not use the first intra prediction mode, the bitstream is parsed to determine second mode usage identification information of the current block. A target prediction mode of the current block is determined according to the second mode usage identification information, and the current block is predicted according to the target prediction mode to determine the prediction block of the current block.

According to a second aspect, an embodiment of the disclosure provides an encoding method, which is applied to an encoder and includes the following operations.

A current block is precoded by using multiple candidate prediction modes to determine prediction blocks corresponding to the multiple candidate prediction modes respectively.

A target prediction mode of the current block is determined from the multiple candidate prediction modes based on the prediction blocks corresponding to the multiple candidate prediction modes.

The current block is predicted according to the target prediction mode to determine a prediction block of the current block.

According to a third aspect, an embodiment of the disclosure provides an encoder, which includes a precoding unit, a first determination unit and a first prediction unit.

The precoding unit is configured to precode a current block by using multiple candidate prediction modes to determine prediction blocks corresponding to the multiple candidate prediction modes respectively.

The first determination unit is configured to determine, based on the prediction blocks corresponding to the multiple candidate prediction modes, a target prediction mode of the current block from the multiple candidate prediction modes.

The first prediction unit is configured to predict the current block according to the target prediction mode to determine a prediction block of the current block.

According to a fourth aspect, an embodiment of the disclosure provides a decoder, which includes a parsing unit and a second prediction unit.

The parsing unit is configured to parse a bitstream to determine first mode usage identification information of a current block.

The second prediction unit is configured to predict, if the first mode usage identification information indicates that the current block uses the first intra prediction mode, the current block according to a first intra prediction mode to determine a prediction block of the current block.

The second prediction unit is further configured to parse, if the first mode usage identification information indicates that the current block does not use the first intra prediction mode, the bitstream to determine second mode usage identification information of the current block, determine a target prediction mode of the current block according to the second mode usage identification information, and predict the current block according to the target prediction mode to determine the prediction block of the current block.

### BRIEF DESCRIPTION OF THE DRAWINGS

FIG. 1 is a diagram of a specific operation process of a DIMD mode.

FIG. 2 is a diagram of a specific operation process of a TMP mode.

FIG. 3A is a diagram of a detailed framework of a video encoding system provided in an embodiment of the disclosure.

FIG. 3B is a diagram of a detailed framework of a video decoding system provided in an embodiment of the disclosure.

FIG. 4 is a flowchart of a decoding method provided in an embodiment of the disclosure.

FIG. 5 is a flowchart of an encoding method provided in an embodiment of the disclosure.

FIG. 6 is a diagram of a compositional structure of an encoder provided in an embodiment of the disclosure.

FIG. 7 is a structural diagram of specific hardware of an encoder provided in an embodiment of the disclosure.

FIG. 8 is a diagram of a compositional structure of a decoder provided in an embodiment of the disclosure.

FIG. 9 is a structural diagram of specific hardware of a decoder provided in an embodiment of the disclosure.

FIG. 10 is a diagram of a compositional structure of an encoding and decoding system provided in an embodiment of the disclosure.

### DETAILED DESCRIPTION

In order to understand characteristics and technical contents of the embodiments of the disclosure more thoroughly, implementations of the embodiments of the disclosure would be described in detail below with reference to the drawings. The drawings are provided for the purpose of reference and illustration only, and are not intended to limit the embodiments of the disclosure.

Unless otherwise defined, all technical and scientific terms used here have the same meaning as usually understood by technicians in the technical field to which the disclosure belongs. The terms used here are only for the purpose of describing the embodiments of the disclosure, and are not intended to limit the disclosure.

In the following descriptions, reference is made to “some embodiments” which describe a subset of all possible embodiments. However, it may be understood that “some embodiments” may be the same or different subsets of all possible embodiments, and may be combined with each other without conflict. It should also be noted that terms “first\second\third” involved in the embodiments of the disclosure are only intended to distinguish similar objects and do not represent a specific order of the objects. It may be understood that “first\second\third” may exchange their specific orders or sequences in an allowable situation, so that the embodiments of the disclosure described here may be implemented in an order other than those illustrated or described here.

Before the embodiments of the disclosure are further described in detail, nouns and terms involved in the embodiments of the disclosure are explained, and the nouns and terms involved in the embodiments of the disclosure are applicable to the following explanations:
Joint Video Experts Team (JVET)
New generation video coding standard H.266/Versatile Video Coding (VVC)
VVC Test Model (VTM)
Merge technology (Merge)
Skip technology (Skip)
Coding Unit (CU)
Prediction Unit (PU)
Transform Unit (TU)
Largest Coding Unit (LCU)
Enhanced Compression Model (ECM)
Decoder side Intra Mode Derivation (DIMD)
Template Matching Prediction (TMP)
Template based Intra Mode Derivation (TIMD)
Matrix based Intra Prediction (MIP).

It may be understood that at present, common video encoding and decoding standards (such as H.266/VVC) adopt a block-based hybrid coding framework. Each frame in a video image may be partitioned into square LCUs with the same size (such as 128×128, 64×64, etc.). Each LCU may be divided into rectangular CUs according to rules. Further, CUs may also be divided into PUs, TUs, etc. Specifically, the hybrid coding framework may include modules such as a prediction module, a transform module, a quantization module, an entropy coding module, an in loop filter module, etc. The prediction module may include intra prediction and inter prediction, and the inter prediction may include motion estimation and motion compensation. Since there is a strong correlation between adjacent pixels in a frame of the video image, usage of an intra prediction mode in the video coding and decoding technologies may eliminate a spatial redundancy between adjacent pixels. Since there is also a strong similarity between adjacent frames in the video image, usage of an inter prediction mode in the video coding and decoding technologies eliminates a temporal redundancy between adjacent frames, thereby improving encoding and decoding efficiencies.

In a specific example, basic flow of a video encoder/decoder is as follows:

At the encoder side, a frame of the video image is divided into blocks. Intra prediction or inter prediction is used in a current block (CB) to generate a prediction block of the current block. The prediction block is subtracted from an original picture block of the current block to obtain a residual block. The residual block is transformed and quantized to obtain a quantization coefficient matrix, and the quantization coefficient matrix is entropy-coded and output to a bitstream.

At the decoder side, the intra prediction or the inter prediction is used in the current block to generate the prediction block of the current block. Furthermore, the bitstream is parsed to obtain the quantization coefficient matrix. The quantization coefficient matrix is inversely quantized and inversely transformed to obtain the residual block, and the prediction block and the residual block are added to obtain a reconstructed block. A reconstructed picture is composed according to the reconstructed block, and in-loop filtering is performed on the reconstructed picture based on the picture or based on the block to obtain a decoded picture.

It should be noted that the encoder side also needs operations similar to those at the decoder side to obtain the decoded picture, and the decoded picture may be used as a reference frame of inter prediction for subsequent frames. Furthermore, block division information determined at the encoder side, mode information or parameter information such as prediction, transform, quantization, entropy coding, in loop filtering or the like, need to be output to the bitstream if necessary. Then, by means of parsing and analyzing according to existing information, the decoder side determines block division information, mode information or parameter information such as prediction, transform, quantization, entropy coding, in loop filtering or the like, which are the same as those at the encoding side, to ensure that the decoded picture obtained at the encoding side is the same as the decoded picture obtained at the decoding side. Here, the decoded picture obtained at the encoder side is also referred to as the reconstructed picture usually. The current block may be divided into PUs during prediction, and the current block may be divided into TUs during transform. Division of PUs may be different from division of TUs.

It should also be noted that the above descriptions are basic flow of the video encoder and decoder under the block-based hybrid coding framework. With the continuous development of technologies, some modules or operations of the framework or flow may be optimized. In the embodiments of the disclosure, the current block may be a current CU, a current PU, or even a current TU, etc.

It may also be understood that the international video coding standard setting organization has established a research group of a coding mode1 surpassing H.266/VVC, and named the mode1 (i.e., platform test software) as ECM. ECM begins to receive newer and more efficient compression algorithms based on VTM10.0, which has coding performance surpassing VVC by about 13% at present. ECM not only expands sizes of CUs with a specific resolution, but also integrates many intra prediction and inter prediction technologies. Specifically, in the embodiments of the disclosure, the following intra prediction technologies are given, for example:

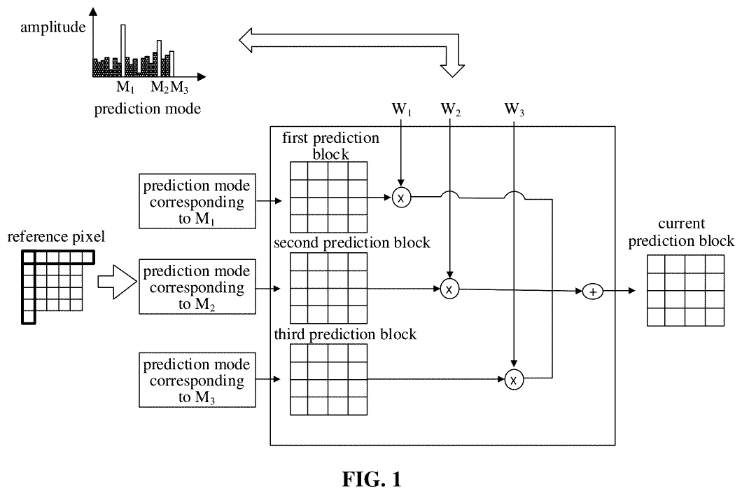

A first intra prediction technology is a DIMD mode. With regard to the intra prediction mode, the decoder side uses the same method as the encoder side to derive the intra prediction mode to avoid transmitting an index serial number of the intra prediction mode of the current CU in the bitstream, thereby achieving a purpose of saving bit overhead. Specific processes are divided into two main operations. At a first operation, a prediction mode is derived. The same prediction mode intensity calculation method is used in the encoder and decoder. Taking ECM2.0 as an example, a Sobel operator is used at the encoder side to count a histogram of gradients in each prediction mode. An active region is three rows of adjacent reconstructed samples above the current block, three columns of adjacent reconstructed samples at the left of the current block and a corresponding adjacent reconstructed sample at the upper left of the current block. A first prediction mode corresponding to a largest amplitude and a second prediction mode corresponding to a second largest amplitude from the histogram of gradients may be obtained by calculating the histogram of gradients of the foregoing L-shaped region. The decoder side derives the first prediction mode and the second prediction mode with the same step. At a second operation, a prediction block is derived. The same prediction block derivation mode is used in the encoder and decoder to obtain the current prediction block. Still taking ECM2.0 as an example, the encoder determines the following two conditions: (1) a gradient of the second prediction mode is not 0; (2) neither the first prediction mode nor the second prediction mode is a PLANAR mode or DC mode. If the above two conditions are not established simultaneously, the current prediction block uses only the first prediction mode to calculate a prediction sample value of the current block. That is, prediction processes of a normal prediction mode are applied to the first prediction mode. Otherwise, if the above two conditions are established, the current prediction block would use a weighted averaging mode to derive the current prediction block. A specific method is that the PLANAR mode occupies ⅓ of a weighted weight, and remaining ⅔ includes that the first prediction mode uses a ratio of a gradient intensity of the first prediction mode to a sum of gradient intensities of the first prediction mode and the second prediction mode as a weighted weight, and the second prediction mode uses a ratio of a gradient intensity of the second prediction mode to the sum of gradient intensities of the first prediction mode and the second prediction mode as a weighted weight. In the above three prediction modes, i.e., the PLANAR mode, the first prediction mode and the second prediction mode, the prediction block of the current CU is obtained by using the weighted averaging mode. The decoder side obtains the prediction block of the current CU with the same operation. Specific operation processes of the DIMD mode is shown in FIG. 1 for details. In FIG. 1, M₁ and M₂ represent a maximum amplitude value and a second maximum amplitude value (i.e., a sub-maximum amplitude value) respectively. M₁ corresponds to the first prediction mode, and a first prediction block (Pred₁) is obtained at this time. M₂ corresponds to the second prediction mode, and a second prediction block (Pred₂) is obtained at this time. M₃ represents that it is fixed to the PLANAR mode, and a third prediction block (Pred₃) is obtained at this time. W₁, W₂, W₃ represent weighted weights of Pred₁, Pred₂, Pred₃ respectively. The current prediction block is finally obtained after the weighted averaging mode.

Here, with regard to the three weighted weights W₁, W₂, W₃, it is assumed that W₁ represents the weighted weight of the first prediction mode, which may be represented by Weight(mode1). W₂ represents the weighted weight of the second prediction mode, which may be represented by Weight(mode2). W₃ represents the weighted weight of the PLANAR mode, which may be represented by Weight(PLANAR). Specific calculation formulas are as follows:

$$\\ Weight ( PLANAR ) = 1 / 3$$

$$\\ Weight ( mode 1 ) = 2 / 3 \times ( amp 1 / ( amp 1 + amp 2 ) )$$

$$\\ Weight ( mode 2 ) = 1 - Weight ( PLANAR ) - Weight ( mode 1 )$$

Here, mode1 and mode2 represent the first prediction mode and the second prediction mode respectively, and amp1 and amp2 represent a gradient amplitude value of the first prediction mode and a gradient amplitude value of the second prediction mode respectively.

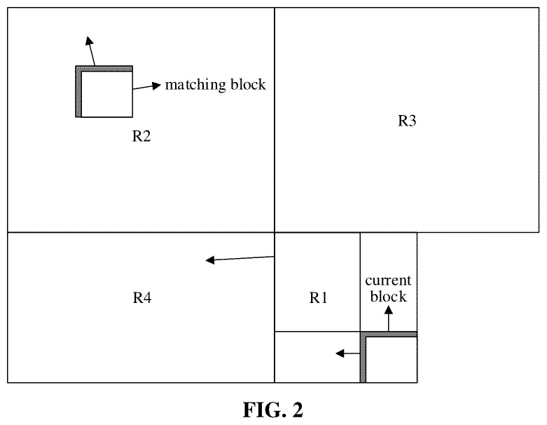

A second intra prediction technology is a TMP mode which may copy a reconstructed block in the current frame. Specific processes are also divided into two main operations. At a first operation, the encoder side uses an L-shaped template to search within a specified range of the current frame to find a best matching region. The specified region may include four regions: R1 is the current CTU region. R2 is the upper left CTU region. R3 is the upper CTU region. R4 is the left CTU region. The search range may be obtained by multiplying width and height of the current block by a preset coefficient. In the search process, a Sum of Absolute Difference (SAD) of the L-shaped region is calculated, and a smallest SAD position is searched and matched. At a second operation, a copy process is performed. Guided by the smallest SAD cost L-shaped template, the reconstructed area, which size is identical to current CU and adjacent to the L-shaped template, would be copied to current block as a prediction block. At the decoder side, the same operation step as those of the encoder may be performed to obtain the same best prediction block as the encoder side. Specific operation processes of the TMP mode is shown in FIG. 2 for details. In FIG. 2, R1 is the current CTU region. R2 is the upper left CTU region. R3 is the upper CTU region. R4 is the left CTU region. With respect to the current block, the best matching region found first is R2. Then, a block with the same shape and size corresponding to the smallest SAD position is searched and found therefrom, which is a matching block of the current block. Furthermore, in normal cases, in order to reduce complexity and implementation overhead of this technology, the TMP mode may only be applied to CUs whose width and height are not greater than 64.

In summary, a core point of the DIMD mode is that the decoder side derives the intra prediction mode to save bit overhead. However, the decoder side still needs to calculate prediction samples according to the derived intra prediction mode to obtain the prediction block. A core point of the TMP mode is that after searching the best matching region, a reconstructed block corresponding thereto is copied as the prediction block of the current CU, and it is not necessary to repeatedly calculate prediction samples according to the intra prediction mode at the decoder side. In other words, considering from the perspective of technical essence, the DIMD mode and the TMP mode are intra prediction technologies, while operation principles and processes of the DIMD mode and the TMP mode are not coupled there-between.

It may be seen that in ECM, the DIMD mode and the TMP mode are not distinguished from each other. Even though the current CU uses the DIMD mode at the encoder side, it still needs to transmit a flag in the bitstream to represent whether the TMP mode is used in the current CU. Similarly, when the decoder side parses that a usage flag of the DIMD mode is true, it still needs to parse a usage flag of the TMP mode at a next step. In this way, compression efficiencies of encoding and decoding standard technologies can be reduced, and redundant operations on software and hardware can be introduced, which causes poor encoding and decoding performance.

On the above basis, an embodiment of the disclosure provides an encoding method. In the encoding method, a current block is precoded by using multiple candidate prediction modes to determine prediction blocks corresponding to multiple candidate prediction modes respectively. A target prediction mode of the current block is determined from the multiple candidate prediction modes based on the prediction blocks corresponding to the multiple candidate prediction modes. The current block is predicted according to the target prediction mode to determine a prediction block of the current block.

An embodiment of the disclosure further provides a decoding method. In the decoding method, a bitstream is parsed to determine first mode usage identification information of a current block. If the first mode usage identification information indicates that the current block uses a first intra prediction mode, the current block is predicted according to the first intra prediction mode to determine a prediction block of the current block. If the first mode usage identification information indicates that the current block does not use the first intra prediction mode, the bitstream is parsed to determine second mode usage identification information of the current block. A target prediction mode of the current block is determined according to the second mode usage identification information, and the current block is predicted according to the target prediction mode to determine the prediction block of the current block.

In this way, since it is impossible for the same current block to use two intra prediction modes simultaneously, when it is obtained by decoding that the current block uses the first intra prediction mode, the second mode usage identification information does not need to be parsed any more, and only when it is obtained by decoding that the current block does not use the first intra prediction mode, the second mode usage identification information needs to be parsed at this time, which may not only improve compression efficiency, but also reduce energy consumption and overhead of software and hardware, thereby improving encoding and decoding performance.

Each embodiment of the disclosure would be described in detail below with reference to the drawings.

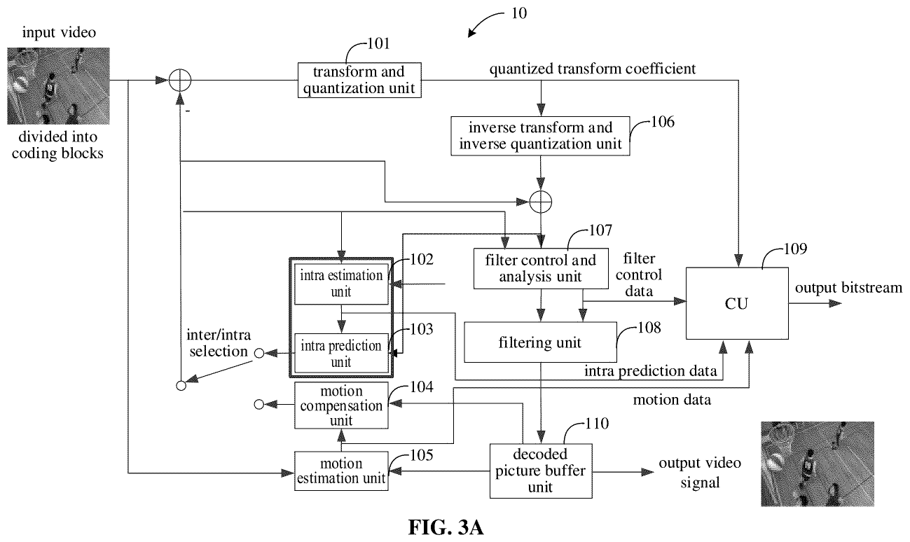

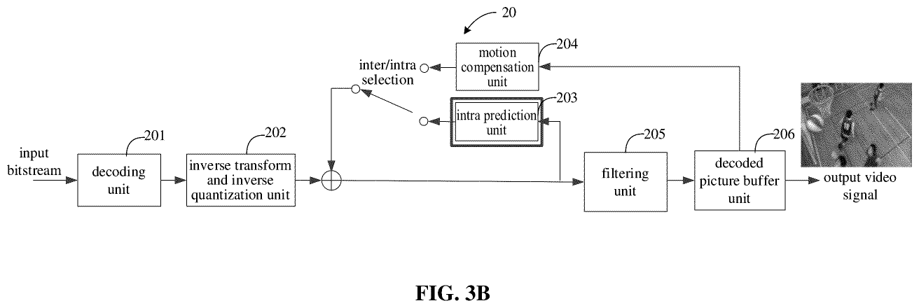

With reference to FIG. 3A, a diagram of a detailed framework of a video encoding system provided in an embodiment of the disclosure is shown. As shown in FIG. 3A, the video encoding system 10 includes a transform and quantization unit 101, an intra estimation unit 102, an intra prediction unit 103, a motion compensation unit 104, a motion estimation unit 105, an inverse transform and inverse quantization unit 106, and a filter control and analysis unit 107, a filtering unit 108, a CU 109, a decoded picture buffer unit 110, etc. The filtering unit 108 may implement deblocking filter (DBF) filtering/sample adaptive offset (SAO) filtering/adaptive loop filter (ALF) filtering, and the CU 109 may implement header information coding and Context-based Adaptive Binary Arithmetic Coding (CABAC). With respect to an input original video signal, a video coding block may be obtained by dividing a Coding Tree Unit (CTU), and then with respect to residual pixel information obtained after subjecting to intra or inter prediction, the video coding block is transformed by the transform and quantization unit 101, which includes: transforming the residual information from a pixel domain to a transform domain, and quantizing obtained transform coefficients to further reduce a bit rate. The intra estimation unit 102 and the intra prediction unit 103 are configured to perform intra prediction on the video coding block. Specifically, the intra estimation unit 102 and the intra prediction unit 103 are configured to determine an intra prediction mode to be used to encode the video coding block. The motion compensation unit 104 and the motion estimation unit 105 is configured to perform inter prediction encoding of the received video coding block relative to one or more blocks in one or more reference frames to provide temporal prediction information. Motion estimation performed by the motion estimation unit 105 is a process of generating a motion vector. The motion vector may estimate motion of the video coding block. Then the motion compensation unit 104 performs motion compensation based on the motion vector determined by the motion estimation unit 105. After determining the intra prediction mode, the intra prediction unit 103 is further configured to provide selected intra prediction data to the CU 109, and the motion estimation unit 105 also sends calculated and determined motion vector data to the CU 109. Furthermore, the inverse transform and inverse quantization unit 106 is used for reconstruction of the video coding block and reconstructs a residual block in the pixel domain. Blocking artifacts are removed from the reconstructed residual block by the filter control and analysis unit 107 and the filtering unit 108. Then the reconstructed residual block is added to a predictive block in a frame of the decoded picture buffer unit 110 to generate a reconstructed video coding block. The CU 109 is configured to encode various coding parameters and quantized transform coefficients. In a CABAC-based coding algorithm, context contents may be based on adjacent coding blocks, and may be configured to encode information indicating the determined intra prediction mode and output a bitstream of the video signal. The decoded picture buffer unit 110 is configured to store the reconstructed video coding block as a reference for prediction. As the video image encoding proceeds, new reconstructed video coding blocks may be continuously generated, and these reconstructed video coding blocks may be stored in the decoded picture buffer unit 110.

With reference to FIG. 3B, a diagram of a detailed framework of a video decoding system provided in an embodiment of the disclosure is shown. As shown in FIG. 3B, the video decoding system 20 includes a decoding unit 201, an inverse transform and inverse quantization unit 202, an intra prediction unit 203, a motion compensation unit 204, a filtering unit 205, a decoded picture buffer unit 206, etc. The decoding unit 201 may implement header information decoding and CABAC decoding, and the filtering unit 205 may implement DBF filtering/SAO filtering/ALF filtering. After the input video signal is subjected to encoding processes of FIG. 3A, a bitstream of the video signal is output. The bitstream is input into the video decoding system 20 and passes through the decoding unit 201 first to obtain decoded transform coefficients. The transform coefficients are processed by the inverse transform and inverse quantization unit 202 to generate a residual block in the pixel domain. The intra prediction unit 203 may be configured to generate prediction data for the current video decoding block based on the determined intra prediction mode and data from previously decoded blocks of the current frame or picture. The motion compensation unit 204 determines prediction information for the video decoding block by parsing motion vectors and other associated syntax elements, and uses the prediction information to generate a predictive block of the video decoding block being decoded. A decoded video block is formed by summing the residual block from the inverse transform and inverse quantization unit 202 and the corresponding predictive block generated by the intra prediction unit 203 or the motion compensation unit 204. The decoded video signal passes through the filtering unit 205 to remove blocking artifacts, so that video quality may be improved. Then, the decoded video block is stored in the decoded picture buffer unit 206. The decoded picture buffer unit 206 is configured to store reference pictures for subsequent intra prediction or motion compensation, and is also configured to output a video signal, that is, the restored original video signal is obtained.

It should be noted that the methods provided in the embodiments of the disclosure may be applied to an intra prediction part as shown in FIG. 3A, which may specifically include the intra estimation unit 102 and the intra prediction unit 103 (indicated by a black bold block). Alternatively, the methods may be applied to an intra prediction part as shown in FIG. 3B, which may specifically include the intra prediction unit 203 (indicated by a black bold block). That is, the methods in the embodiments of the disclosure mainly affect the intra prediction part in the video coding hybrid framework. The methods may be applied to the video encoding system (referred to as “encoder” for abbreviation), or may be applied to the video decoding system (referred to as “decoder” for abbreviation), or may even be applied to the video encoding system and the video decoding system simultaneously, which is not limited here.

It should also be noted that when the embodiments of the disclosure are applied to the encoder, “current block” specifically refers to a block currently to be encoded in the video image (which may also be referred to as a “coding block” for abbreviation). When the embodiments of the disclosure are applied to the decoder, “current block” specifically refers to a block currently to be decoded in the video image (which may also be referred to as a “decoding block” for abbreviation).

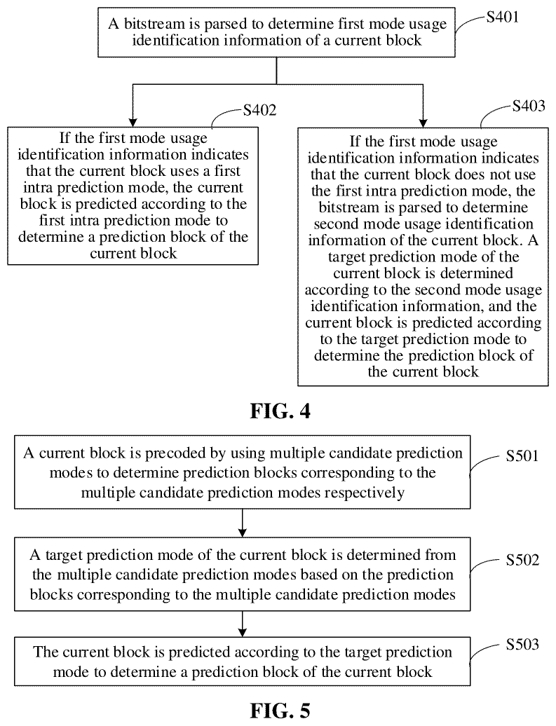

In an embodiment of the disclosure, with reference to FIG. 4, a flowchart of a decoding method provided in an embodiment of the disclosure is shown. As shown in FIG. 4, the method may include the following operations S401 to S403.

At S401, a bitstream is parsed to determine first mode usage identification information of a current block.

It should be noted that a video image may be divided into multiple picture blocks, and each picture block currently to be decoded may be referred to as a decoding block. Here, each decoding block may include a first colour component, a second colour component and a third colour component. The current block is a decoding block in the video image for which prediction of the first colour component, the second colour component or the third colour component is performed currently.

It should also be noted that the three colour components, i.e., the first colour component, the second colour component and the third colour component are one luma component and two chroma components respectively. Assuming that the prediction of the first colour component is performed for the current block and the first colour component is the luma component, the current block may also be referred to as a luma block. Alternatively, assuming that the prediction of the second colour component is performed for the current block and the second colour component is the chroma component, the current block may also be referred to as a chroma block.

In the embodiment of the disclosure, with regard to the current block, no matter it is the luma block or the chroma block, there may be multiple candidate prediction modes for the current block. In order to enable the decoder side to use the same prediction mode as the encoder to derive a prediction block of the current block, mode usage identification information such as the first mode usage identification information and second mode usage identification information needs to be transmitted in the bitstream. Here, the first mode usage identification information may be configured to indicate whether the current block uses a first intra prediction mode, and the second mode usage identification information may be configured to indicate whether the current block uses a second intra prediction mode.

The first intra prediction mode may be a TMP mode, and the second intra prediction mode may be a DIMD mode. Alternatively, the first intra prediction mode may be a DIMD mode, and the second intra prediction mode may be a TMP mode. However, no matter it is the first intra prediction mode or the second intra prediction mode, it may also be other prediction modes, such as a TIMD mode, a MIP mode, etc., which is not limited in the embodiments of the disclosure.

In this way, the first mode usage identification information may be obtained first in the decoder by parsing the bitstream to determine whether the current block uses the first intra prediction mode.

At S402, if the first mode usage identification information indicates that the current block uses a first intra prediction mode, the current block is predicted according to the first intra prediction mode to determine a prediction block of the current block.

At S403, if the first mode usage identification information indicates that the current block does not use the first intra prediction mode, the bitstream is parsed to determine second mode usage identification information of the current block. A target prediction mode of the current block is determined according to the second mode usage identification information, and the current block is predicted according to the target prediction mode to determine the prediction block of the current block.

It should be noted that if the first mode usage identification information indicates that the current block uses the first intra prediction mode, it is not necessary to perform decoding to obtain the second mode usage identification information, and the current block is directly predicted according to the first intra prediction mode to determine the prediction block of the current block. However, if the first mode usage identification information indicates that the current block does not use the first intra prediction mode, it needs to continue decoding to obtain the second mode usage identification information. The target prediction mode of the current block is determined according to the second mode usage identification information, and the current block is predicted according to the target prediction mode to determine the prediction block of the current block.

It should also be noted that after determining the prediction block of the current block, a reconstructed block of the current block may also be determined on the above basis. Specifically, in some embodiments, the method may further include the following operations.

The bitstream is parsed to determine a quantization coefficient matrix.

Inverse quantization and inverse transform are performed on the quantization coefficient matrix to obtain a residual block of the current block.

A reconstructed block of the current block is obtained according to the prediction block and the residual block.

In a specific example, the operation that the reconstructed block of the current block is obtained according to the prediction block and the residual block may include the operation that the prediction block is added to the residual block to obtain the reconstructed block of the current block.

That is, the decoder may also determine the quantization coefficient matrix by parsing the bitstream, and then inverse quantization and inverse transform are performed on the quantization coefficient matrix to obtain the residual block of the current block. Then the prediction block is added to the residual block to obtain the reconstructed block of the current block. Furthermore, it should also be noted that after all the reconstructed blocks are subjected to processes such as in-loop filtering or the like, a final reconstructed picture is obtained, which may at the same time be used as a video output and as a reference for subsequent decoding.

Further, with regard to the first mode usage identification information, in some embodiments, the method may further include the following operations.

If a value of the first mode usage identification information is a first value, it is determined that the first mode usage identification information indicates that the current block uses the first intra prediction mode.

If the value of the first mode usage identification information is a second value, it is determined that the first mode usage identification information indicates that the current block does not use the first intra prediction mode.

In the embodiments of the disclosure, the first value is different from the second value, and each of the first value and the second value may be in a parameter form or in a numeric form. Specifically, the first mode usage identification information may be a parameter written into a profile or may be a value of a flag, which would not be limited in the embodiments of the disclosure.

Taking the first mode usage identification information being a flag as an example, at this time, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, with regard to the flag, in normal cases, the first value is equal to 1 and the second value is equal to 0, which would not be limited here.

It may be understood that before decoding to obtain the first mode usage identification information, the decoder also needs decoding to determine whether the current block uses an intra prediction mode or an inter prediction mode first. When the intra prediction mode is used, the decoder also needs decoding to determine whether the current block is allowed to use the first intra prediction mode and the second intra prediction mode. Therefore, in some embodiments, the method may further include the following operations.

The bitstream is parsed to determine type identification information.

If the type identification information indicates that the current block uses an intra prediction mode, the bitstream is parsed to determine first mode permission identification information and second mode permission identification information of the current block.

In a case that the first mode permission identification information indicates that the current block is allowed to use the first intra prediction mode and the second mode permission identification information indicates that the current block is allowed to use a second intra prediction mode, the operation of parsing the bitstream to determine the first mode usage identification information of the current block is performed.

It should be noted that the type identification information may be configured to indicate whether the current block uses the intra prediction mode; the first mode permission identification information may be configured to indicate whether the current block is allowed to use the first intra prediction mode, and the second mode permission identification information may be configured to indicate whether the current block is allowed to use the second intra prediction mode.

It should also be noted that the type identification information may be a level flag of one of a CU level, a sequence level, a picture level, a slice level, a block level, or even a higher level, such as Video Usability Information (VUI), Supplemental Enhancement Information (SEI), etc. Each of the first mode permission identification information and the second mode permission identification information may be a level flag of one of a CU level, a sequence level, a picture level, a slice level, a block level, or even a higher level (such as VUI, SEI, etc.). In a specific example, the type identification information is a flag of a CU level type, and each of the first mode permission identification information and the second mode permission identification information is a sequence level flag, which would not be limited in the embodiments of the disclosure.

In some embodiments, with regard to the type identification information, the method may further include the following operations.

If a value of the type identification information is a first value, it is determined that the type identification information indicates that the current block uses the intra prediction mode.

If the value of the type identification information is a second value, it is determined that the type identification information indicates that the current block does not use the intra prediction mode.

In some embodiments, with regard to the first mode permission identification information, the method may further include the following operations.

If a value of the first mode permission identification information is a first value, it is determined that the first mode permission identification information indicates that the current block is allowed to use the first intra prediction mode.

If the value of the first mode permission identification information is a second value, it is determined that the first mode permission identification information indicates that the current block is not allowed to use the first intra prediction mode.

In some embodiments, with regard to the second mode permission identification information, the method may further include the following operations.

If a value of the second mode permission identification information is a first value, it is determined that the second mode permission identification information indicates that the current block is allowed to use the second intra prediction mode.

If the value of the second mode permission identification information is a second value, it is determined that the second mode permission identification information indicates that the current block is not allowed to use the second intra prediction mode.

Here, the first value is still different from the second value, and each of the first value and the second value may be in a parameter form or in a numeric form. Specifically, no matter it is the type identification information, the first mode permission identification information or the second mode permission identification information, it may be a parameter written into a profile, or may be a value of a flag, which would not be limited in the embodiments of the disclosure.

Still taking the flag as an example, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, the first value is equal to 1 and the second value is equal to 0, which would not be limited.

Further, the respective intra prediction mode corresponding to each of the first intra prediction mode and the second intra prediction mode may be specifically related to an initial parsing order of the current block. In some embodiments, the method may further include the following operations.

An initial parsing order of the current block is set.

The first intra prediction mode and the second intra prediction mode are determined according to the initial parsing order.

It should be noted that in the embodiments of the disclosure, the initial parsing order at least includes one of:
a DIMD mode and a TMP mode; or
the TMP mode and the DIMD mode.

That is, when the initial parsing order is the DIMD mode and the TMP mode, it is determined that the first intra prediction mode parsed first is the DIMD mode, and the second intra prediction mode parsed subsequently is the TMP mode. Alternatively, when the initial parsing order is the TMP mode and the DIMD mode, it is determined that the first intra prediction mode parsed first is the TMP mode, and the second intra prediction mode parsed subsequently is the DIMD mode.

Further, with regard to the initial parsing order, in some embodiments, the method may further include the following operations.

Auxiliary adjustment information of the current block is determined.

The initial parsing order is adjusted according to the auxiliary adjustment information of the current block to obtain an adjusted parsing order.

The first intra prediction mode and the second intra prediction mode are determined according to the adjusted parsing order.

It should be noted that in the embodiments of the disclosure, the auxiliary adjustment information may include block size information and/or frame type information.

It should also be noted that in the embodiments of the disclosure, the operation of adjusting the initial parsing order according to the block size information of the current block may specifically include the following operations. If the block size information conforms to a preset size range, it is determined that the adjusted parsing order is the DIMD mode and the TMP mode. If the block size information does not conform to the preset size range, it is determined that the adjusted parsing order is the TMP mode and the DIMD mode.

Exemplarily, if an area of the current block is less than 1024, the DIMD mode may be parsed first, and then the TMP mode may be parsed. Otherwise, the TMP mode may be parsed first, and then the DIMD mode may be parsed.

It should also be noted that in the embodiments of the disclosure, the operation of adjusting the initial parsing order according to the frame type information of the current block may specifically include the following operations. If the frame type information conforms to a bidirectional reference frame type, it is determined that the adjusted parsing order is the DIMD mode and the TMP mode. If the frame type information conforms to an intra frame type, it is determined that the adjusted parsing order is the TMP mode and the DIMD mode.

Exemplarily, if a frame to which the current block belongs is a bidirectional reference frame, the DIMD mode may be parsed first, and then the TMP mode may be parsed. Otherwise, if the frame to which the current block belongs is an intra frame, the TMP mode may be parsed first, and then the DIMD mode1 may be parsed.

Further, in some embodiments, the operation of determining the target prediction mode of the current block according to the second mode usage identification information may include the following operations.

If the second mode usage identification information indicates that the current block uses a second intra prediction mode, the second intra prediction mode is determined as the target prediction mode of the current block.

If the second mode usage identification information indicates that the current block does not use the second intra prediction mode, the bitstream is parsed to determine third mode usage identification information of the current block, and the target prediction mode of the current block is determined according to the third mode usage identification information.

It should be noted that if it is determined from decoding that the current block does not use the first intra prediction mode but the current block uses the second intra prediction mode, the second intra prediction mode may be determined as the target prediction mode of the current block. Then the current block may be predicted according to the second intra prediction mode to determine the prediction block of the current block. Otherwise, if it is determined from decoding that the current block does not use the first intra prediction mode and the current block does not use the second intra prediction mode either, it still needs decoding to determine the third mode usage identification information of the current block so as to determine the target prediction mode of the current block, so that the current block may be predicted according to the target prediction mode, thereby determining the prediction block of the current block.

Here, the third mode usage identification information is configured to indicate whether the current block uses remaining intra prediction modes except the first intra prediction mode and the second intra prediction mode. In this way, the target prediction mode finally used by the current block may be determined according to the third mode usage identification information, and then the current block may be predicted according to the target prediction mode to determine the prediction block of the current block.

In a specific embodiment, assuming that the first intra prediction mode is the DIMD mode and the second intra prediction mode is the TMP mode, the first mode permission identification information may be represented by sps_dimd_enable_flag, and the second mode permission identification information may be represented by sps_tmp_enable_flag.

Specifically, in the decoder, the current block is the current CU. First, a CU level type flag is determined by parsing. If it is the intra prediction mode, usage permission flags of the DIMD mode and the TMP mode are determined by parsing. These flags are sequence level flags and indicate whether the decoder is allowed to use the DIMD mode and the TMP mode currently. If the usage permission flags of both the DIMD mode and the TMP mode are true, it means that the decoder is allowed to use the DIMD mode and the TMP mode, then the following operations are performed.

At a first operation, a usage flag of the DIMD mode of the current CU is parsed. If the usage flag of the DIMD mode is true, it continues to perform the following operations; otherwise, it is skipped to a second operation. The current CU uses the DIMD mode, and the same method as the encoder is used to derive prediction mode information of the current CU. The prediction block of the current CU is determined according to the prediction mode information, and then the reconstructed block of the current CU may be obtained by superimposing the prediction block of the current CU on the residual block after the inverse transform and the inverse quantization. At this time, the second operation and a third operation are skipped.

At the second operation, a usage flag of the TMP mode of the current CU is continued to be parsed. If the usage flag of the TMP mode is true, the following operations are continued to be performed. Otherwise, it is skipped to the third operation. The current CU uses the TMP mode, and the same method as the encoder is used to find a best matched reconstructed block as the prediction block of the current CU. The reconstructed block of the current CU may be obtained by superimposing the prediction block of the current CU on the residual block after the inverse transform and the inverse quantization. At this time, the third operation is skipped.

At the third operation, usage flags of other prediction modes are continued to be parsed. Prediction modes of which usage flags are true are used to obtain the prediction block of the current CU, and the reconstructed block of the current CU may be obtained by superimposing the prediction block of the current CU on the residual block after the inverse transform and the inverse quantization. Other processes are not elaborated here.

In this way, after all reconstructed blocks are subjected to processes such as in-loop filtering or the like, a final reconstructed picture is obtained, which may at the same time be used as a video output and as a reference for subsequent decoding.

In another specific embodiment, assuming that the first intra prediction mode is the TMP mode and the second intra prediction mode is the DIMD mode, the first mode permission identification information may be represented by sps_tmp_enable_flag, and the second mode permission identification information may be represented by sps_dimd_enable_flag.

Specifically, in the decoder, the current block is the current CU. First, a CU level type flag is determined by parsing. If it is the intra prediction mode, usage permission flags of the TMP mode and the DIMD mode are determined by parsing. These flags are sequence level flags and indicate whether the decoder is allowed to use the TMP mode and the DIMD mode currently. If the usage permission flags of both the TMP mode and the DIMD mode are true, it means that the decoder is allowed to use the TMP mode and the DIMD mode, then the following operations are performed.

At a first operation, a usage flag of the TMP mode of the current CU is parsed. If the usage flag of the TMP mode is true, the following operations are continued to be performed. Otherwise, it is skipped to a second operation. The current CU uses the TMP mode, and the same method as the encoder is used to find a best matched reconstructed block as the prediction block of the current CU. The reconstructed block of the current CU may be obtained by superimposing the prediction block of the current CU on the residual block after the inverse transform and the inverse quantization. At this time, the second operation and a third operation are skipped.

At the second operation, a usage flag of the DIMD mode of the current CU is continued to be parsed. If the usage flag of the DIMD mode is true, it continues to perform the following operations; otherwise, it is skipped to the third operation. The current CU uses the DIMD mode, and the same method as the encoder is used to derive prediction mode information of the current CU. The prediction block of the current CU is determined according to the prediction mode information, and then the reconstructed block of the current CU may be obtained by superimposing the prediction block of the current CU on the residual block after the inverse transform and the inverse quantization. At this time, the third operation is skipped.

At the third operation, usage flags of other prediction modes are continued to be parsed. Prediction modes of which usage flags are true are used to obtain the prediction block of the current CU, and the reconstructed block of the current CU may be obtained by superimposing the prediction block of the current CU on the residual block after the inverse transform and the inverse quantization. Other processes are not elaborated here.

In this way, after all reconstructed blocks are subjected to processes such as in-loop filtering or the like, a final reconstructed picture is obtained, which may at the same time be used as a video output and as a reference for subsequent decoding.

In the embodiments of the disclosure, with respect to other prediction modes, a TIMD mode is also proposed here. In ECM2.0, this mode is similar to the DIMD mode. However, processes of derivation of the intra prediction mode and generation of the prediction block are different. The TIMD mode is a template based intra mode derivation technology, and a template is constructed based on available information of reconstructed samples at the upper, left and upper left of the current CU. If information of all the above adjacent reconstructed samples are available, the template has a L-shape. Prediction samples in the template are generated according to the prediction mode, and Sum of Absolute Transformed Difference (SATD) cost information of the prediction samples and the reconstructed samples in the template is calculated. A prediction mode corresponding to a minimum SATD cost value is the first prediction mode, and a prediction mode corresponding to a second minimum SATD cost value is the second prediction mode. Then, according to the SATD cost information of the first prediction mode and the second prediction mode, whether the prediction blocks of the two prediction modes are fused is decided. Specifically, if the SATD cost value of the second prediction mode is less than twice the SATD cost value of the first prediction mode, a weighted averaging calculation is performed on the prediction blocks generated by the two prediction modes. Otherwise, the prediction block is generated by using only the first prediction mode. Here, weighted weights are as follows:

weight1=costMode2/(costMode1+costMode2)

weight2=1−weight1

Weight1 denotes the weighted weight corresponding to the first prediction mode. Weight2 denotes the weighted weight corresponding to the second prediction mode. CostMode1 denotes the SATD cost value of the first prediction mode. CostMode2 denotes the SATD cost value of the second prediction mode.

However, the DIMD mode and the TIMD mode have the same operation principles. The DIMD mode and the TIMD mode cannot be applied to the same CU simultaneously, and cannot be applied to the same CU together with the TMP mode simultaneously either. In this way, with respect to three intra prediction modes, i.e., the DIMD mode, the TIMD mode and the TMP mode, the embodiments of the disclosure may also effectively couple relationships and orders among various modes, so that not only compression efficiencies of video encoding and decoding standard technologies may be improved, but also energy consumption and overhead of software and hardware may be reduced.

Specifically, when the decoder determines, by means of decoding, that the current block is in the intra prediction mode, it also needs decoding to determine whether the current block is allowed to use the first intra prediction mode, the second intra prediction mode and the third intra prediction mode. Therefore, in some embodiments, the operation of parsing the bitstream to determine the first mode usage identification information of the current block may include the following operations.

The bitstream is parsed to determine type identification information.

If the type identification information indicates that the current block uses an intra prediction mode, the bitstream is parsed to determine first mode permission identification information, second mode permission identification information and third mode permission identification information of the current block.

In a case that the first mode permission identification information indicates that the current block is allowed to use the first intra prediction mode, the second mode permission identification information indicates that the current block is allowed to use the second intra prediction mode, and the third mode permission identification information indicates that the current block is allowed to use a third intra prediction mode, the bitstream is parsed to determine the first mode usage identification information of the current block.

It should be noted that before determining whether the current block uses the first intra prediction mode, the decoder needs to determine whether the current block is allowed to use these intra prediction modes first. The first mode permission identification information may be configured to indicate whether the current block is allowed to use the first intra prediction mode. The second mode permission identification information may be configured to indicate whether the current block is allowed to use the second intra prediction mode. The third mode permission identification information may be configured to indicate whether the current block is allowed to use the third intra prediction mode.

Here, the type identification information may be a level flag of one of a CU level, a sequence level, a picture level, a slice level, a block level, or even a higher level (such as VUI, SEI, etc.). Each of the first mode permission identification information, the second mode permission identification information and the third mode permission identification information may be a level flag of one of a CU level, a sequence level, a picture level, a slice level, a block level, or even a higher level (such as VUI, SEI, etc.). In a specific example, the type identification information is a CU level type flag, and each of the first mode permission identification information, the second mode permission identification information and the third mode permission identification information is a sequence level flag, which would not be limited in the embodiments of the present disclosure.

In some embodiments, with regard to the third mode permission identification information, the method may further include the following operations.

If a value of the third mode permission identification information is a first value, it is determined that the third mode permission identification information indicates that the current block is allowed to use the third intra prediction mode.

If the value of the third mode permission identification information is a second value, it is determined that the third mode permission identification information indicates that the current block is not allowed to use the third intra prediction mode.

That is, in the decoder, the first mode permission identification information, the second mode permission identification information and the third mode permission identification information are decoded. If it is determined that the current block is allowed to use the first intra prediction mode, the second intra prediction mode and the third intra prediction mode, it also needs to set an initial parsing order of the current block to further reduce energy consumption and overhead of software and hardware. In some embodiments, the method may further include the following operations.

An initial parsing order of the current block is set.

The first intra prediction mode, the second intra prediction mode and the third intra prediction mode are determined according to the initial parsing order.

It should be noted that in the embodiments of the disclosure, the initial parsing order includes at least one of:
the DIMD mode, the TIMD mode and the TMP mode;
the TIMD mode, the DIMD mode and the TMP mode;
the DIMD mode, the TMP mode and the TIMD mode;
the TIMD mode, the TMP mode and the DIMD mode;
the TMP mode, the DIMD mode and the TIMD mode; or
the TMP mode, the TIMD mode and the DIMD mode.

Exemplarily, when the initial parsing order is the DIMD mode, the TIMD mode and the TMP mode, it is determined that the first intra prediction mode parsed first is the DIMD mode, that the second intra prediction mode parsed subsequently is the TIMD mode, and that the third intra prediction mode parsed subsequently is the TMP mode. When the initial parsing order is the TIMD mode, the DIMD mode and the TMP mode, it is determined that the first intra prediction mode parsed first is the TIMD mode, that the second intra prediction mode parsed subsequently is the DIMD mode and that the third intra prediction mode parsed subsequently is the TMP mode.

Further, in some embodiments, the method may further include the following operations.

Auxiliary adjustment information of the current block is determined.

The initial parsing order is adjusted according to the auxiliary adjustment information of the current block to obtain an adjusted parsing order.

The first intra prediction mode, the second intra prediction mode and the third intra prediction mode are determined according to the adjusted parsing order.

It should be noted that in the embodiments of the disclosure, the auxiliary adjustment information may include block size information and/or frame type information.

It should also be noted that in the embodiments of the disclosure, the initial parsing order is adjusted according to the block size information of the current block. Exemplarily, if the block size information conforms to a preset size range, it is determined that the TMP mode is parsed first, the DIMD mode is parsed subsequently, and then the TIMD mode is parsed. If the block size information does not conform to the preset size range, it is determined that the TMP mode is parsed first, the TIMD mode is parsed subsequently, and then the DIMD mode is parsed.

It should also be noted that in the embodiments of the disclosure, the initial parsing order is adjusted according to the frame type information of the current block. Exemplarily, if the frame type information conforms to a bidirectional reference frame type, it is determined that the initial parsing order is maintained, that is, the parsing order remains unchanged. If the frame type information conforms to an intra frame type, it is determined that the initial parsing order is adjusted.

Further, in some embodiments, the target prediction mode of the current block is determined according to the third mode usage identification information, which may include the following operations.

If the third mode usage identification information indicates that the current block uses the third intra prediction mode, the third intra prediction mode is determined as the target prediction mode of the current block.

If the third mode usage identification information indicates that the current block does not use the third intra prediction mode, the bitstream is parsed to determine fourth mode usage identification information of the current block, and the target prediction mode of the current block is determined according to the fourth mode usage identification information.

In the embodiments of the disclosure, the method may further include the following operations.

If a value of the third mode usage identification information is a first value, it is determined that the third mode usage identification information indicates that the current block uses the third intra prediction mode.

If the value of the third mode usage identification information is a second value, it is determined that the third mode usage identification information indicates that the current block does not use the third intra prediction mode.

Here, the first value is different from the second value, and each of the first value and the second value may be in a parameter form or in a numeric form. Specifically, no matter it is the third mode permission identification information or the third mode usage identification information, it may be a parameter written into a profile, or may be a value of a flag, which would not be limited in the embodiments of the present disclosure.

Still taking the flag as an example, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, the first value is equal to 1 and the second value is equal to 0, which would not be limited.

It should also be noted that if it is determined from decoding that the first mode usage identification information indicates that the current block does not use the first intra prediction mode, that the second mode usage identification information indicates that the current block does not use the second intra prediction mode, and that the third mode usage identification information indicates that the current block uses the third intra prediction mode, the third intra prediction mode may be determined as the target prediction mode of the current block, and the current block may be predicted according to the third intra prediction mode to determine the prediction block of the current block. Otherwise, if it is determined from decoding that the first mode usage identification information indicates that the current block does not use the first intra prediction mode, that the second mode usage identification information indicates that the current block does not use the second intra prediction mode, and that the third mode usage identification information indicates that the current block does not use the third intra prediction mode, it still needs decoding to determine the fourth mode usage identification information of the current block so as to determine the target prediction mode of the current block, so that the current block may be predicted according to the target prediction mode, thereby determining the prediction block of the current block.

Here, the fourth mode usage identification information is configured to indicate whether the current block uses remaining intra prediction modes except the first intra prediction mode, the second intra prediction mode and the third intra prediction mode. In this way, the target prediction mode finally used by the current block may be determined according to the fourth mode usage identification information, and the current block is predicted according to the target prediction mode to determine the prediction block of the current block.

In a specific embodiment, assuming that the first intra prediction mode is the DIMD mode, that the second intra prediction mode is the TIMD mode and that the third intra prediction mode is the TMP mode, the first mode permission identification information is represented by sps_dimd_enable_flag, the second mode permission identification information is represented by sps_timd_enable_flag, and the third mode permission identification information is represented by sps_tmp_enable_flag.

Specifically, in the decoder, the current block is the current CU. First, a CU level type flag is determined by parsing. If it is the intra prediction mode, usage permission flags of the DIMD mode, the TIMD mode and the TMP mode are determined by parsing. These flags are sequence level flags and indicate whether the decoder is allowed to use the DIMD mode, the TIMD mode and the TMP mode currently. If usage permission flags of the DIMD mode, the TIMD mode and the TMP mode are true, it means that the decoder is allowed to use the DIMD mode, the TIMD mode and the TMP mode, and the following operations are performed.

At a first operation, a usage flag of the DIMD mode of the current CU is parsed. If the usage flag of the DIMD mode is true, the following operations are continued to be performed. Otherwise, it is skipped to a second operation. The current CU uses the DIMD mode, and the same method as the encoder is used to derive prediction mode information of the current CU. The prediction block of the current CU is determined according to the prediction mode information, and the reconstructed block of the current CU may be obtained by superimposing the prediction block of the current CU on the residual block after the inverse transform and the inverse quantization. At this time, the second operation, a third operation and a fourth operation are skipped.

At the second operation, a usage flag of the TIMD mode of the current CU is continued to be parsed. If the usage flag of the TIMD mode is true, the following operations are continued to be performed. Otherwise, it is skipped to the third operation. The current CU uses the TIMD mode. The same method as the encoder is used to derive prediction mode information of the current CU. The prediction block of the current CU is determined according to the prediction mode information, and the reconstructed block of the current CU may be obtained by superimposing the prediction block of the current CU on the residual block after the inverse transform and the inverse quantization. At this time, the third operation and the fourth operation are skipped.

At the third operation, a usage flag of the TMP mode of the current CU is continued to be parsed. If the usage flag of the TMP mode is true, the following operations are continued to be performed. Otherwise, it is skipped to the fourth operation. The current CU uses the TMP mode, and the same method as the encoder is used to find a best matched reconstructed block as the prediction block of the current CU. The reconstructed block of the current CU may be obtained by superimposing the prediction block of the current CU on the residual block after the inverse transform and the inverse quantization. At this time, the fourth is skipped.

At the fourth operation, usage flags of other prediction modes are continued to be parsed. Prediction modes of which usage flags are true are used to obtain the prediction block of the current CU, and the reconstructed block of the current CU may be obtained by superimposing the prediction block of the current CU on the residual block after the inverse transform and the inverse quantization. Other processes are not elaborated here.

In this way, after all reconstructed blocks are subjected to processes such as in-loop filtering or the like, a final reconstructed picture is obtained, which may at the same time be used as a video output and as a reference for subsequent decoding.

In another specific embodiment, assuming that the first intra prediction mode is the TIMD mode, that the second intra prediction mode is the DIMD mode and that the third intra prediction mode is the TMP mode, the first mode permission identification information is represented by sps_timd_enable_flag, the second mode permission identification information is represented by sps_dimd_enable_flag, and the third mode permission identification information is represented by sps_tmp_enable_flag.

Specifically, in the decoder, the current block is the current CU. First, a CU level type flag is determined by parsing. If it is the intra prediction mode, usage permission flags of the TIMD mode, the DIMD mode and the TMP mode are determined by parsing. These flags are sequence level flags and indicate whether the decoder is allowed to use the TIMD mode, the DIMD mode and the TMP mode currently. If usage permission flags of the TIMD mode, the DIMD mode and the TMP mode are true, it means that the decoder is allowed to use the TIMD mode, the DIMD mode and the TMP mode, and the following operations are performed.

At a first operation, a usage flag of the TIMD mode of the current CU is parsed. If the usage flag of the TIMD mode is true, the following operations are continued to be performed. Otherwise, it is skipped to the second operation. The current CU uses the TIMD mode. The same method as the encoder is used to derive prediction mode information of the current CU. The prediction block of the current CU is determined according to the prediction mode information, and the reconstructed block of the current CU may be obtained by superimposing the prediction block of the current CU on the residual block after the inverse transform and the inverse quantization. At this time, the second operation, a third operation and a fourth operation are skipped.

At the second operation, a usage flag of the DIMD mode of the current CU is continued to be parsed. If the usage flag of the DIMD mode is true, it continues to perform the following operations; otherwise, it is skipped to the third operation. The current CU uses the DIMD mode, and the same method as the encoder is used to derive prediction mode information of the current CU. The prediction block of the current CU is determined according to the prediction mode information, and then the reconstructed block of the current CU may be obtained by superimposing the prediction block of the current CU on the residual block after the inverse transform and the inverse quantization. At this time, the third operation and the fourth operation are skipped.

At the third operation, a usage flag of the TMP mode of the current CU is continued to be parsed. If the usage flag of the TMP mode is true, the following operations are continued to be performed. Otherwise, it is skipped to the fourth operation. The current CU uses the TMP mode, and the same method as the encoder is used to find a best matched reconstructed block as the prediction block of the current CU. The reconstructed block of the current CU may be obtained by superimposing the prediction block of the current CU on the residual block after the inverse transform and the inverse quantization. At this time, the fourth is skipped.

At the fourth operation, usage flags of other prediction modes are continued to be parsed. Prediction modes of which usage flags are true are used to obtain the prediction block of the current CU, and the reconstructed block of the current CU may be obtained by superimposing the prediction block of the current CU on the residual block after the inverse transform and the inverse quantization. Other processes are not elaborated here.

In this way, after all reconstructed blocks are subjected to processes such as in-loop filtering or the like, a final reconstructed picture is obtained, which may at the same time be used as a video output and as a reference for subsequent decoding.

In the embodiments of the disclosure, with respect to the other prediction modes, a MIP mode is also proposed here. However, with respect to four intra prediction modes (i.e., the DIMD mode, the TIMD mode, the TMP mode and the MIP mode), the four modes are mutually exclusive, and a case where two or more modes are used simultaneously does not exist. The embodiments of the disclosure may also effectively couple relationships and orders among various modes, so that not only compression efficiencies of video encoding and decoding standard technologies may be improved, but also energy consumption and overhead of software and hardware may be reduced.

Specifically, when the decoder determines from decoding that the current block uses the intra prediction mode, it also needs decoding to determine whether the current block is allowed to use the first intra prediction mode, the second intra prediction mode, the third intra prediction mode and the fourth intra prediction mode. Therefore, in some embodiments, the operation of parsing the bitstream to determine the first mode usage identification information of the current block may include the following operations.

The bitstream is parsed to determine type identification information.

If the type identification information indicates that the current block uses the intra prediction mode, the bitstream is parsed to determine first mode permission identification information, second mode permission identification information, third mode permission identification information and fourth mode permission identification information of the current block.

In a case that the first mode permission identification information indicates that the current block is allowed to use the first intra prediction mode, the second mode permission identification information indicates that the current block is allowed to use the second intra prediction mode, the third mode permission identification information indicates that the current block is allowed to use the third intra prediction mode, and the fourth mode permission identification information indicates that the current block is allowed to use a fourth intra prediction mode, the bitstream is parsed to determine the first mode usage identification information of the current block.

It should be noted that before determining whether the current block uses the first intra prediction mode, the decoder needs to determine whether the current block is allowed to use these intra prediction modes first. The first mode permission identification information may be configured to indicate whether the current block is allowed to use the first intra prediction mode. The second mode permission identification information may be configured to indicate whether the current block is allowed to use the second intra prediction mode. The third mode permission identification information may be configured to indicate whether the current block is allowed to use the third intra prediction mode. The fourth mode permission identification information may be configured to indicate whether the current block is allowed to use the fourth intra prediction mode.

Here, the type identification information may be a level flag of one of a CU level, a sequence level, a picture level, a slice level, a block level, or even a higher level such as VUI, SEI, etc. Each of the first mode permission identification information, the second mode permission identification information, the third mode permission identification information and the fourth mode permission identification information may be a level flag of one of a CU level, a sequence level, a picture level, a slice level, a block level, or even a higher level (such as VUI, SEI, etc.). In a specific example, the type identification information is still a CU level type flag, and each of the first mode permission identification information, the second mode permission identification information and the third mode permission identification information is still a sequence level flag, which would not be limited in the embodiments of the disclosure.

In some embodiments, with regard to the fourth mode permission identification information, the method may further include the following operations.

If a value of the fourth mode usage identification information is a first value, it is determined that the fourth mode usage identification information indicates that the current block is allowed to use the fourth intra prediction mode.

If the value of the fourth mode usage identification information is a second value, it is determined that the fourth mode usage identification information indicates that the current block is not allowed to use the fourth intra prediction mode.

That is, in the decoder, the first mode permission identification information, the second mode permission identification information, the third mode permission identification information and the fourth mode permission identification information are decoded. If it is determined that the current block is allowed to use the first intra prediction mode, the second intra prediction mode, the third intra prediction mode and the fourth intra prediction mode, it also needs to set an initial parsing order of the current block to further reduce energy consumption and overhead of software and hardware. In some embodiments, the method may further include the following operations.

An initial parsing order of the current block is set.

The first intra prediction mode, the second intra prediction mode, the third intra prediction mode and the fourth intra prediction mode are determined according to the initial parsing order.

It should be noted that in the embodiments of the disclosure, the initial parsing order includes at least one of:
a DIMD mode, a TMP mode, a MIP mode and a TIMD mode;
the TMP mode, the TIMD mode, the MIP mode and the DIMD mode; or
the TIMD mode, the DIMD mode, the TMP mode and the MIP mode.

Furthermore, the initial parsing order may also be the DIMD mode, the TMP mode, the TIMD mode and the MIP mode. Alternatively, the initial parsing order may also be the DIMD mode, the MIP mode, the TMP mode and the TIMD mode. Alternatively, the initial parsing order may also be the DIMD mode, the MIP mode, the TIMD mode and the TMP mode. Alternatively, the initial parsing order may also be the DIMD mode, the TIMD mode, the TMP mode and the MIP mode. Alternatively, the initial parsing order may also be the DIMD mode, the TIMD mode, the MIP mode and the TMP mode. Alternatively, the initial parsing order may also be the TMP mode, the TIMD mode, the DIMD mode and the MIP mode, etc. Any limitation is not made here.

Exemplarily, when the initial parsing order is the DIMD mode, the TMP mode, the MIP mode and the TIMD mode, it is determined that the first intra prediction mode parsed first may be the DIMD mode, the second intra prediction mode parsed subsequently may be the TMP mode, the third intra prediction mode parsed subsequently may be the MIP mode, and the fourth intra prediction mode parsed subsequently may be the TIMD mode.

Further, in some embodiments, the method may further include the following operations.

Auxiliary adjustment information of the current block is determined.

The initial parsing order is adjusted according to the auxiliary adjustment information of the current block to obtain an adjusted parsing order.

The first intra prediction mode, the second intra prediction mode, the third intra prediction mode and the fourth intra prediction mode are determined according to the adjusted parsing order.

It should be noted that in the embodiments of the disclosure, the auxiliary adjustment information may include block size information and/or frame type information.

That is, in the embodiments of the disclosure, different parsing orders may be determined according to different types of the current frame. For example, if the current frame is a bidirectional reference frame, the parsing order may remain unchanged. If the current frame is an intra frame, the parsing order of these prediction modes may be adjusted. Furthermore, in the embodiments of the disclosure, different parsing orders may also be determined according to different sizes of CUs. For example, if an area of the current CU is less than 1024, the DIMD mode may be parsed first, and then the TIMD mode may be parsed. Otherwise, the TIMD mode may be parsed first, and then the DIMD mode may be parsed.

Further, in some embodiments, the operation of determining the target prediction mode of the current block according to the fourth mode usage identification information may include the following operations.

If the fourth mode usage identification information indicates that the current block uses a fourth intra prediction mode, the fourth intra prediction mode is determined as the target prediction mode of the current block.

If the fourth mode usage identification information indicates that the current block does not use the fourth intra prediction mode, the bitstream is parsed to determine fifth mode usage identification information of the current block, and determining the target prediction mode of the current block according to the fifth mode usage identification information.

In the embodiments of the disclosure, the method may further include the following operations.

If a value of the fourth mode usage identification information is a first value, it is determined that the fourth mode usage identification information indicates that the current block uses the fourth intra prediction mode.

If the value of the fourth mode usage identification information is a second value, it is determined that the fourth mode usage identification information indicates that the current block does not use the fourth intra prediction mode.

Here, the first value is different from the second value, and each of the first value and the second value may be in a parameter form or in a numeric form. Specifically, no matter it is the fourth mode permission identification information or the fourth mode usage identification information, it may be a parameter written into a profile, or may be a value of a flag, which would not be limited in the embodiments of the disclosure.

Still taking the flag as an example, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, the first value is equal to 1 and the second value is equal to 0, which would not be limited.

It should also be noted that if it is determined from decoding that the first mode usage identification information indicates that the current block does not use the first intra prediction mode, that the second mode usage identification information indicates that the current block does not use the second intra prediction mode, that the third mode usage identification information indicates that the current block does not use the third intra prediction mode and that the fourth mode usage identification information indicates that the current block uses the fourth intra prediction mode, the fourth intra prediction mode may be determined as the target prediction mode of the current block, and then the current block may be predicted according to the fourth intra prediction mode to determine the prediction block of the current block. Otherwise, if it is determined from decoding that the first mode usage identification information indicates that the current block does not use the first intra prediction mode, that the second mode usage identification information indicates that the current block does not use the second intra prediction mode, that the third mode usage identification information indicates that the current block does not use the third intra prediction mode, and that the fourth mode usage identification information indicates that the current block does not use the fourth intra prediction mode, it still needs decoding to determine the fifth mode usage identification information of the current block to determine the target prediction mode of the current block, so that the current block may be predicted according to the target prediction mode, thereby determining the prediction block of the current block.

In the embodiments of the disclosure, the fifth mode usage identification information may be configured to indicate whether the current block uses a fifth intra prediction mode, and the fifth intra prediction mode is a remaining intra prediction mode except the first intra prediction mode, the second intra prediction mode, the third intra prediction mode and the fourth intra prediction mode. In this way, the target prediction mode finally used by the current block may be determined according to the fifth mode usage identification information, and then the current block is predicted according to the target prediction mode to determine the prediction block of the current block.

In a specific embodiment, assuming that the first intra prediction mode is the DIMD mode, that the second intra prediction mode is the TMP mode, that the third intra prediction mode is the MIP mode and that the fourth intra prediction mode is the TIMD mode, the first mode permission identification information can be represented by sps_dimd_enable_flag, the second mode permission identification information can be represented by sps_tmp_enable_flag, the third mode permission identification information can be represented by sps_mip_enable_flag, and the fourth mode permission identification information can be represented by sps_timd_enable_flag.

Specifically, in the decoder, the current block is the current CU. First, a CU level type flag is determined by parsing. If it is the intra prediction mode, usage permission flags of the DIMD mode, the TMP mode, the MIP mode and the TIMD mode are determined by parsing. These flags are sequence level flags and indicate whether the decoder is allowed to use the DIMD mode, the TMP mode, the MIP mode and the TIMD mode currently. If usage permission flags of the DIMD mode, the TMP mode, the MIP mode and the TMP mode are true, the following operations are performed.

At a first operation, a usage flag of the DIMD mode of the current CU is parsed. If the usage flag of the DIMD mode is true, the following operations are continued to be performed. Otherwise, it is skipped to a second operation. The current CU uses the DIMD mode, and the same method as the encoder is used to derive prediction mode information of the current CU. The prediction block of the current CU is determined according to the prediction mode information, and the reconstructed block of the current CU may be obtained by superimposing the prediction block of the current CU on the residual block after the inverse transform and the inverse quantization. At this time, the second operation, a third operation, a fourth operation and a fifth operation are skipped.

At the second operation, a usage flag of the TMP mode of the current CU is continued to be parsed. If the usage flag of the TMP mode is true, the following operations are continued to be performed. Otherwise, it is skipped to the third operation. The current CU uses the TMP mode, and the same method as the encoder is used to find a best matched reconstructed block as the prediction block of the current CU. The reconstructed block of the current CU may be obtained by superimposing the prediction block of the current CU on the residual block after the inverse transform and the inverse quantization. At this time, the third operation, the fourth operation and the fifth operation are skipped.

At the third operation, a usage flag of the MIP mode of the current CU continues to be parsed. If the usage flag of the MIP mode is true, the following operations are continued to be performed. Otherwise, it is skipped to the fourth operation. The current CU uses the MIP mode, and the index serial number of the MIP mode is parsed to obtain prediction matrix information. The prediction block of the current CU is generated. The reconstructed block of the current CU may be obtained by superimposing the prediction block of the current CU on the residual block after the inverse transform and the inverse quantization. At this time, the fourth operation and the fifth operation are skipped.

At the fourth operation, a usage flag of the TIMD mode of the current CU is continued to be parsed. If the usage flag of the TIMD mode is true, the following operations are continued to be performed. Otherwise, it is skipped to the fifth operation. The current CU uses the TIMD mode. The same method as the encoder is used to derive prediction mode information of the current CU. The prediction block of the current CU is determined according to the prediction mode information, and the reconstructed block of the current CU may be obtained by superimposing the prediction block of the current CU on the residual block after the inverse transform and the inverse quantization. At this time, the fifth operation is skipped.

At the fifth operation, usage flags of other prediction modes are continued to be parsed. Prediction modes of which usage flags are true are used to obtain the prediction block of the current CU, and the reconstructed block of the current CU may be obtained by superimposing the prediction block of the current CU on the residual block after the inverse transform and the inverse quantization. Other processes are not elaborated here.

In this way, after all reconstructed blocks are subjected to processes such as in-loop filtering or the like, a final reconstructed picture is obtained, which may at the same time be used as a video output and as a reference for subsequent decoding.

It should also be noted that CU size limitation may be added to the above embodiments, and these parsing orders may be switched. For example, the decoder may follow a parsing order as follows: the usage flag of the TMP mode, the usage flag of the TIMD mode, the usage flag of the MIP mode, the usage flag of the DIMD mode, and usage flags of other prediction modes, or may follow a parsing order as follows: the usage flag of the TIMD mode, the usage flag of the DIMD mode, the usage flag of the TMP mode, the usage flag of the MIP mode, and usage flags of other prediction modes.

In short, in the embodiments of the disclosure, the DIMD mode and the TMP mode are not used in the same CU simultaneously. If the usage flag of the DIMD mode is parsed to be true, the usage flag of the TMP mode does not need to be parsed any more. If the usage flag of the DIMD mode is parsed to be false, it is necessary to continue to parse the usage flag of the TMP mode. Similarly, usage cases of the DIMD mode, the TMP mode, the MIP mode and the TIMD mode may also be coupled. That is, the four modes are mutually exclusive, and a case where two or more modes are used simultaneously does not exist. Therefore, the embodiments of the disclosure provide several parsing orders and corresponding parsing cases.

The technical solution of the embodiments of the disclosure is applicable to intra prediction parts of the encoder and decoder. After integrating the technical solution into ECM2.0, test results under all general test conditions are as follows. Table 1 shows test results under an All Intra (AI) condition. Table 2 shows test results under a Random Access (RA) condition. Table 3 shows test results under a Low Delay B (LDB) condition.

TABLE 1

| | | | | | |
|---|---|---|---|---|---|
| Class F | BasketballDrillText | 22 | −0.01% | 0.04% | 0.08% |
| | | 27 | | | |
| | | 32 | | | |
| | | 37 | | | |
| | ArenaOfValor | 22 | −0.01% | 0.01% | −0.01% |
| | | 27 | | | |
| | | 32 | | | |
| | | 37 | | | |
| | SlideEditing | 22 | −0.02% | −0.17% | −0.11% |
| | | 27 | | | |
| | | 32 | | | |
| | | 37 | | | |
| | SlideShow | 22 | −0.17% | −0.56% | −0.29% |
| | | 27 | | | |
| | | 32 | | | |
| | | 37 | | | |
| | Class F | | −0.05% | −0.17% | −0.08% |

TABLE 2

| | | | | | |
|---|---|---|---|---|---|
| Class F | BasketballDrillText | 22 | −0.05% | 0.13% | −0.10% |
| | | 27 | | | |
| | | 32 | | | |
| | | 37 | | | |
| | ArenaOfValor | 22 | −0.05% | −0.03% | −0.05% |
| | | 27 | | | |
| | | 32 | | | |
| | | 37 | | | |
| | SlideEditing | 22 | −0.04% | 0.20% | −0.13% |
| | | 27 | | | |
| | | 32 | | | |
| | | 37 | | | |
| | SlideShow | 22 | 0.04% | −0.20% | −1.19% |
| | | 27 | | | |
| | | 32 | | | |
| | | 37 | | | |
| | Class F | | −0.03% | 0.02% | −0.37% |

TABLE 3

| | | | | | |
|---|---|---|---|---|---|
| Class F | BasketballDrillText | 22 | 0.02% | −0.35% | −0.18% |
| | | 27 | | | |
| | | 32 | | | |
| | | 37 | | | |
| | ArenaOfValor | 22 | −0.02% | 0.04% | 0.28% |
| | | 27 | | | |
| | | 32 | | | |
| | | 37 | | | |
| | SlideEditing | 22 | −0.35% | −0.50% | −1.26% |
| | | 27 | | | |
| | | 32 | | | |
| | | 37 | | | |
| | SlideShow | 22 | −0.37% | −0.64% | −2.08% |
| | | 27 | | | |
| | | 32 | | | |
| | | 37 | | | |
| | Class F | | −0.18% | −0.36% | −0.81% |

It may be seen from the test results in the above three tables that the technical solution has improved performance for all general test conditions of AI, RA and LDB. The performance improvement of LDB is the most apparent, and an average of 0.18% BD-bitrate is saved. Furthermore, parsing time can be reduced, and context parsing efficiency of the technical solution on hardware can also be improved.

The embodiments provide a decoding method. A bitstream is parsed to determine first mode usage identification information of a current block. If the first mode usage identification information indicates that the current block uses a first intra prediction mode, the current block is predicted according to the first intra prediction mode to determine a prediction block of the current bloc. If the first mode usage identification information indicates that the current block does not use the first intra prediction mode, the bitstream is parsed to determine second mode usage identification information of the current block, and the prediction block of the current block is determined according to the second mode usage identification information. In this way, since it is impossible for the same current block to use two intra prediction modes simultaneously, when it is obtained by decoding that the current block uses the first intra prediction mode, the second mode usage identification information does not need to be parsed any more, and only when it is obtained by decoding that the current block does not use the first intra prediction mode, the second mode usage identification information needs to be parsed at this time, which may not only improve compression efficiency, but also reduce energy consumption and overhead of software and hardware, thereby improving decoding performance.

In another embodiment of the disclosure, with reference to FIG. 5, a flowchart of an encoding method provided in an embodiment of the disclosure is shown. As shown in FIG. 5, the method includes the following operations S501 to S503.

At S501, a current block is precoded by using multiple candidate prediction modes to determine prediction blocks corresponding to the multiple candidate prediction modes respectively.

It should be noted that a video image may be divided into multiple picture blocks, and each picture block currently to be encoded may be referred to as an encoding block. Here, each encoding block may include a first colour component, a second colour component and a third colour component. The current block is an encoding block in the video image for which prediction of the first colour component, the second colour component or the third colour component is performed currently.

It should also be noted that in the embodiment of the disclosure, there may be multiple candidate prediction modes for the current block, and it is necessary to select a candidate prediction mode as a target prediction mode from the multiple candidate prediction modes, so that the current block may be predicted according to the target prediction mode subsequently. Therefore, with respect to the multiple candidate prediction modes, the current block may be precoded respectively to obtain the prediction blocks corresponding to the multiple candidate prediction modes.

At S502, a target prediction mode of the current block is determined from the multiple candidate prediction modes based on the prediction blocks corresponding to the multiple candidate prediction modes.

In the embodiment of the disclosure, after obtaining the prediction blocks corresponding to multiple candidate prediction modes respectively, a distortion value of each of the multiple candidate prediction modes may be determined. In a specific embodiment, it may be determined according to a Rate Distortion Optimization (RDO) cost result, or may be determined according to a SAD cost result, or even may be determined according to a SATD cost result, which would not be limited here.

In some embodiments, taking a rate distortion cost value as an example, with regard to S502, the operation of determining the target prediction mode of the current block from the multiple candidate prediction modes based on the prediction blocks corresponding to the multiple candidate prediction modes may include the following operations.

Rate distortion cost values corresponding to multiple candidate prediction modes are determined respectively based on the prediction blocks corresponding to the multiple candidate prediction modes.

A minimum rate distortion cost value is selected from the rate distortion cost values corresponding to the multiple candidate prediction modes.

A candidate prediction mode corresponding to the minimum rate distortion cost value is determined as the target prediction mode of the current block.

It should be noted that all of the multiple candidate prediction modes here refer to the intra prediction modes. The current block is precoded according to the multiple candidate prediction modes, and the prediction blocks corresponding to the multiple candidate prediction modes may be determined respectively. The distortion value corresponding to each of the multiple candidate prediction modes may be determined. Alternatively, the rate distortion cost value corresponding to each of the multiple candidate prediction modes may be determined. Alternatively, even other cost values corresponding to each of the multiple andidate prediction modes may be determined, such as an SAD cost result, an SATD cost result, etc. Exemplarily, after determining the rate distortion cost values corresponding to the multiple candidate prediction modes according to the prediction blocks corresponding to the multiple candidate prediction modes respectively, the minimum rate distortion cost value may be selected from these rate distortion cost values, and the candidate prediction mode corresponding to the minimum rate distortion cost value is determined as the target prediction mode of the current block, so that encoding efficiency may be effectively improved.

It should also be noted that in the encoder, assuming that the multiple candidate prediction modes at least include the first intra prediction mode and the second intra prediction mode (such as the TMP mode and the DIMD mode, etc.), the encoder needs to determine whether the current block uses an intra prediction mode or an inter prediction mode first. When the intra prediction mode is used, it is also necessary to determine whether the current block is allowed to use the first intra prediction mode and the second intra prediction mode. Therefore, in some embodiments, the method may further include the following operations.

In a case that the current block uses an intra prediction mode, it is determined whether the current block is allowed to use the first intra prediction mode and whether the current block is allowed to use the second intra prediction mode.

In a case that the current block is allowed to use the first intra prediction mode and the current block is allowed to use the second intra prediction mode, the operation of precoding the current block by using the multiple candidate prediction modes to determine the prediction blocks corresponding to the multiple candidate prediction modes respectively is performed.

Further, in some embodiments, the method may further include the following operations.

If it is determined that the current block uses the intra prediction mode, a value of type identification information is set to a first value.

If it is determined that the current block does not use the intra prediction mode, the value of the type identification information is set to a second value.

In this case, the method may further include the following operations. The value of the type identification information is encoded, and encoded bits are signalled into a bitstream.

Further, in some embodiments, the method may further include the following operations.

If it is determined that the current block is allowed to use the first intra prediction mode, a value of first mode permission identification information is set to a first value.

If it is determined that the current block is not allowed to use the first intra prediction mode, the value of the first mode permission identification information is set to a second value.

In this case, the method may further include the following operations. The value of the first mode permission identification information is encoded, and encoded bits are signalled into a bitstream.

Further, in some embodiments, the method may further include the following operations.

If it is determined that the current block is allowed to use the second intra prediction mode, a value of second mode permission identification information is set to a first value.

If it is determined that the current block is not allowed to use the second intra prediction mode, the value of the second mode permission identification information is set to a second value.

In this case, the method may further include the following operations. The value of the second mode permission identification information is encoded, and encoded bits are signalled into a bitstream.

In the embodiments of the disclosure, the first value is different from the second value, and each of the first value and the second value may be in a parameter form or in a numeric form. Specifically, no matter it is the type identification information, the first mode permission identification information or the second mode permission identification information, it may be a parameter written into a profile, or may be a value of a flag, which would not be limited in the embodiments of the disclosure.

Taking a flag as an example, at this time, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, with regard to the flag, in normal cases, the first value is equal to 1 and the second value is equal to 0, which would not be limited.

Further, with regard to whether the encoder selects the first intra prediction mode or the second intra prediction mode, or even remaining intra prediction modes (such as the MIP mode, the TIMD mode, etc.) except the first intra prediction mode and the second intra prediction mode, in some embodiments, the operation of precoding the current block by using the multiple candidate prediction modes to determine the prediction blocks corresponding to the multiple candidate prediction modes respectively may further include the following operations.

The current block is precoded by using the first intra prediction mode to determine a first rate distortion cost value.

The current block is precoded by using the second intra prediction mode to determine a second rate distortion cost value.

The current block is precoded by using remaining intra prediction modes except the first intra prediction mode and the second intra prediction mode to determine a third rate distortion cost value.

Accordingly, the operation of determining the target prediction mode of the current block from the multiple candidate prediction modes may include the following operations.

If the first rate distortion cost value is less than any one of the second rate distortion cost value and the third rate distortion cost value, the first intra prediction mode is determined as the target prediction mode of the current block.

If the second rate distortion cost value is less than any one of the first rate distortion cost value and the third rate distortion cost value, the second intra prediction mode is determined as the target prediction mode of the current block.

That is, if the first rate distortion cost value corresponding to the first intra prediction mode is minimum, the first intra prediction mode may be determined as the target prediction mode of the current block. If the second rate distortion cost value corresponding to the second intra prediction mode is minimum, the second intra prediction mode may be determined as the target prediction mode of the current block. If there is a minimum rate distortion cost value in the remaining intra prediction modes, an intra prediction mode corresponding to the minimum rate distortion cost value may be determined as the target prediction mode of the current block.

Further, in some embodiments, the method may further include the following operations.

If it is determined that the current block is predicted by using the first intra prediction mode, a value of first mode usage identification information is set to a first value.

If it is determined that the current block is not predicted by using the first intra prediction mode, the value of the first mode usage identification information is set to a second value.

In this case, the method may further include the following operations. The value of the first mode usage identification information is encoded, and encoded bits are signalled into a bitstream.

Further, in some embodiments, the method may further include the following operations.

If it is determined that the current block is predicted by using the second intra prediction mode, a value of second mode usage identification information is set to a first value.

If it is determined that the current block is not predicted by using the second intra prediction mode, the value of the second mode usage identification information is set to a second value.

In this case, the method may further include the following operations. The value of the second mode usage identification information is encoded, and encoded bits are signalled into a bitstream.

It should be noted that the first value is still different from the second value, and each of the first value and the second value may be in a parameter form or in a numeric form. Specifically, no matter it is the first mode usage identification information or the second mode usage identification information, it may be a parameter written into a profile, or may be a value of a flag, which would not be limited in the embodiments of the disclosure.

Still taking the flag as an example, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, the first value is equal to 1 and the second value is equal to 0, which would not be limited.

It should also be noted that with regard to the first intra prediction mode and the second intra prediction mode, in a specific example, the first intra prediction mode may be a DIMD mode, and the second intra prediction mode may be a TMP mode. Alternatively, in another specific example, the first intra prediction mode may be the TMP mode, and the second intra prediction mode may be the DIMD mode.

In a specific embodiment, assuming that the first intra prediction mode may be the DIMD mode and the second intra prediction mode may be the TMP mode, the first mode permission identification information may be represented by sps_dimd_enable_flag, and the second mode permission identification information may be represented by sps_tmp_enable_flag.

In the encoder, the current block is the current CU. First, the encoder may traverse the multiple candidate prediction modes. If the current CU is in an intra mode, the usage permission flags of the DIMD mode and the TMP mode are obtained. These flags are sequence level flags and indicate whether the encoder is allowed to use the DIMD mode and the TMP mode currently. If the usage permission flags of both the DIMD mode and the TMP mode are true, it means that the encoder is allowed to use the DIMD mode and the TMP mode.

Specifically, if the usage permission flags of both the DIMD mode and the TMP mode are true, the DIMD mode is tried first, and the prediction mode information of the current CU is derived. The prediction block of the current CU is determined according to the prediction mode information. The residual block is obtained. The transform and quantization processes are performed. The first rate distortion cost value corresponding thereto is calculated and recorded as cost1. The TMP mode is continued to be tried. An L-shaped region best matching the current CU is searched. A prediction block corresponding thereto is determined. The residual block is obtained. The transform and quantization processes are performed. The second rate distortion cost value corresponding thereto is calculated and recorded as cost2. Other prediction modes are continued to be tried, and the rate distortion cost values thereof are obtained through corresponding methods, which are recorded as cost3, . . . , costN. Here, the foregoing other prediction modes are not limited, and may include but are not limited to the MIP mode, the TIMD mode, and the like.

If the cost1 is minimum, the current CU uses the DIMD mode, and the usage flag of the DIMD mode is set to “true” and signalled into the bitstream.

If the cost2 is minimum, the current CU uses the TMP mode. The usage flag of the DIMD mode is set to “false” and signalled into the bitstream, while the usage flag of the TMP mode is set to “true” and signalled into the bitstream.

In a case that there is a minimum one among cost3, . . . , costN, the current CU uses other prediction modes. The usage flags of both the DIMD mode and the TMP mode are set to “false” and signalled into the bitstream, and a usage flag of a prediction mode corresponding to the minimum rate distortion cost value is set to “true” and signalled into the bitstream. The specific case is not elaborated.

In another specific embodiment, assuming that the first intra prediction mode is the TMP mode and the second intra prediction mode is the DIMD mode, the first mode permission identification information may be represented by sps_tmp_enable_flag, and the second mode permission identification information may be represented by sps_dimd_enable_flag.

In the encoder, the current block is the current CU. First, the encoder may traverse the multiple candidate prediction modes. If the current CU is in an intra mode, the usage permission flags of the TMP mode and the DIMD mode are obtained. These flags are sequence level flags and indicate whether the encoder is allowed to use the TMP mode and the DIMD mode currently. If the usage permission flags of both the TMP mode and the DIMD mode are true, it means that the encoder is allowed to use the TMP mode and the DIMD mode.

Specifically, if the usage permission flags of both the TMP mode and the DIMD mode are true, the TMP mode is tried first. An L-shaped region best matching the current CU is searched, and a prediction block corresponding thereto is determined. The residual block is obtained. The transform and quantization processes are performed. The first rate distortion cost value corresponding thereto is calculated and recorded as cost1. The DIMD mode is continued to be tried. Prediction mode information of the current CU is derived. The prediction block of the current CU is determined according to the prediction mode information. The residual block is obtained. The transform and quantization processes are performed. The second rate distortion cost value corresponding thereto is calculated and recorded as cost2. Other prediction modes are continued to be tried, and rate distortion cost values thereof are obtained through corresponding methods, which are recorded as cost3, . . . , costN. Here, the foregoing other prediction modes are not limited, which may include but are not limited to the MIP mode, the TIMD mode, and the like.

If the cost1 is minimum, the current CU uses the TMP mode, and the usage flag of the TMP mode is set to “true” and signalled into the bitstream.

If the cost2 is minimum, the current CU uses the DIMD mode. The usage flag of the TMP mode is set to “false” and signalled into the bitstream, and the usage flag of the DIMD mode is set to “true” and signalled into the bitstream.

In a case that there is a minimum one among cost3, . . . , costN, the current CU uses other prediction modes. The usage flags of both the TMP mode and the DIMD mode are set to “false” and signalled into the bitstream, and a usage flag of a prediction mode corresponding to the minimum rate distortion cost value is set to “true” and signalled into the bitstream. The specific case is not elaborated.

In the embodiments of the disclosure, the DIMD mode and the TIMD mode have the same operation principles. The DIMD mode and the TIMD mode cannot be applied to the same CU simultaneously, and cannot be applied to the same CU together with the TMP mode simultaneously, either. In this way, with respect to three intra prediction modes, i.e., the DIMD mode, the TIMD mode and the TMP mode, the embodiments of the disclosure may also effectively couple relationships and orders among various modes, so that not only compression efficiencies of video encoding and decoding standard technologies may be improved, but also energy consumption and overhead of software and hardware may be reduced.

Specifically, in the encoder, assuming that the multiple candidate prediction modes include at least a first intra prediction mode, a second intra prediction mode and a third intra prediction mode (such as the TMP mode, the TIMD mode and the DIMD mode, etc.), the encoder needs to determine whether the current block uses an intra prediction mode or an inter prediction mode first. When the intra prediction mode is used, it is also necessary to determine whether the current block is allowed to use the first intra prediction mode, the second intra prediction mode and the third intra prediction mode. Therefore, in some embodiments, the method may further include the following operations.

In a case that the current block uses an intra prediction mode, whether the current block is allowed to use a first intra prediction mode, whether the current block is allowed to use a second intra prediction mode and whether the current block is allowed to use a third intra prediction mode are determined.

In a case that the current block is allowed to use the first intra prediction mode, the current block is allowed to use the second intra prediction mode and the current block is allowed to use the third intra prediction mode, the operation of precoding the current block by using the multiple candidate prediction modes to determine the prediction blocks corresponding to the multiple candidate prediction modes respectively is performed.

Further, in some embodiments, the method may further include the following operations.

If it is determined that the current block is allowed to use the third intra prediction mode, a value of third mode permission identification information is set to a first value.

If it is determined that the current block is not allowed to use the third intra prediction mode, the value of the third mode permission identification information is set to a second value.

In this case, the method may further include the following operations. The value of the third mode permission identification information is encoded, and encoded bits are signalled into a bitstream.

It should be noted that the first value is different from the second value. Taking the third mode permission identification information being a flag as an example, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, the first value is equal to 1 and the second value is equal to 0, which would not be limited.

Further, with regard to whether the encoder selects the first intra prediction mode, or the second intra prediction mode, or the third intra prediction mode, or even remaining intra prediction modes (such as the MIP mode, normal prediction mode, etc.) except the first intra prediction mode, the second intra prediction mode and the third intra prediction mode, in some embodiments, the operation of precoding the current block by using the multiple candidate prediction modes to determine the prediction blocks corresponding to the multiple candidate prediction modes respectively may further include the following operations.

The current block is precoded by using the first intra prediction mode to determine a first rate distortion cost value.

The current block is precoded by using the second intra prediction mode to determine a second rate distortion cost value.

The current block is precoded by using the third intra prediction mode to determine a third rate distortion cost value.

The current block is precoded by using remaining intra prediction modes except the first intra prediction mode, the second intra prediction mode and the third intra prediction mode to determine a fourth rate distortion cost value.

Accordingly, the operation of determining the target prediction mode of the current block from the multiple candidate prediction modes may include the following operations.

If the first rate distortion cost value is less than any one of the second rate distortion cost value, the third rate distortion cost value and the fourth rate distortion cost value, the first intra prediction mode is determined as the target prediction mode of the current block.

If the second rate distortion cost value is less than any one of the first rate distortion cost value, the third rate distortion cost value and the fourth rate distortion cost value, the second intra prediction mode is determined as the target prediction mode of the current block.

If the third rate distortion cost value is less than any one of the first rate distortion cost value, the second rate distortion cost value and the fourth rate distortion cost value, the third intra prediction mode is determined as the target prediction mode of the current block.

That is, if the first rate distortion cost value corresponding to the first intra prediction mode is minimum, the first intra prediction mode may be determined as the target prediction mode of the current block. If the second rate distortion cost value corresponding to the second intra prediction mode is minimum, the second intra prediction mode may be determined as the target prediction mode of the current block. If the third rate distortion cost value corresponding to the third intra prediction mode is minimum, the third intra prediction mode may be determined as the target prediction mode of the current block. If there is a minimum rate distortion cost value in the remaining intra prediction modes, an intra prediction mode corresponding to the minimum rate distortion cost value may be determined as the target prediction mode of the current block.

Further, in some embodiments, the method may further include the following operations.

If it is determined that the current block is predicted by using the third intra prediction mode, a value of third mode usage identification information is set to a first value.

If it is determined that the current block is not predicted by using the third intra prediction mode, the value of the third mode usage identification information is set to a second value.

In this case, the method may further include the following operations. The value of the third mode usage identification information is encoded, and encoded bits are signalled into a bitstream.

It should be noted that the first value is different from the second value. Taking the third mode usage identification information being a flag as an example, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, the first value is equal to 1 and the second value is equal to 0, which would not be limited.

It should also be noted that with regard to the first intra prediction mode, the second intra prediction mode and the third intra prediction mode, in a specific example, the first intra prediction mode is a DIMD mode, the second intra prediction mode is a TIMD mode, and the third intra prediction mode is a TMP mode. Alternatively, in another specific example, the first intra prediction mode is the TIMD mode, the second intra prediction mode is the DIMD mode, and the third intra prediction mode is the TMP mode. Alternatively, in yet another specific example, the first intra prediction mode is the TMP mode, the second intra prediction mode is the DIMD mode, and the third intra prediction mode is the TIMD mode, etc., which would not be limited here.

In a specific embodiment, assuming that the first intra prediction mode is the DIMD mode, that the second intra prediction mode is the TIMD mode and that the third intra prediction mode is the TMP mode, the first mode permission identification information may be represented by sps_dimd_enable_flag, the second mode permission identification information may be represented by sps_timd_enable_flag, and the third mode permission identification information may be represented by sps_tmp_enable_flag.

In the encoder, the current block is the current CU. First, the encoder may traverse the multiple candidate prediction modes. If the current CU is in an intra mode, usage permission flags of the DIMD mode, the TIMD mode and the TMP mode are obtained. These flags are sequence level flags and indicate whether the encoder is allowed to use the DIMD mode, the TIMD mode and the TMP mode currently. If all the usage permission flags of the DIMD mode, the TIMD mode and the TMP mode are true, it means that the encoder is allowed to use the DIMD mode, the TIMD mode and the TMP mode.

Specifically, if all the usage permission flags of the DIMD mode, the TIMD mode and the TMP mode are true, the DIMD mode is tried first. Prediction mode information of the current CU is derived. The prediction block of the current CU is determined according to the prediction mode information. The residual block is obtained. The transform and quantization processes are performed, and the first rate distortion cost value corresponding thereto is calculated and recorded as cost1. The TIMD mode is continued to be tried. Prediction mode information of the current CU is derived. The prediction block of the current CU is generated according to the prediction mode information. The residual block is obtained. The transform and quantization processes are performed, and the second rate distortion cost value corresponding thereto is calculated and recorded as cost2. The TMP mode is continued to be tried. An L-shaped region best matching the current CU is searched. A prediction block corresponding thereto is determined. The residual block is obtained. The transform and quantization processes are performed, and the third rate distortion cost value corresponding thereto is calculated and recorded as cost3. Other prediction modes are continued to be tried, and the rate distortion cost values thereof are obtained through corresponding methods, which are recorded as cost4, . . . , costN. Here, the foregoing other prediction modes are not limited, and may include, but are not limited to, the MIP mode, the normal prediction mode, and the like.

If the cost1 is minimum, the current CU uses the DIMD mode, and the usage flag of the DIMD mode is set to “true” and signalled into the bitstream.

If cost2 is minimum, the current CU uses the TIMD mode. The usage flag of the DIMD mode is set to “false” and signalled into the bitstream, and the usage flag of the TIMD mode is set to “true” and signalled into the bitstream.

If cost3 is minimum, the current CU uses the TMP mode, usage flags of both the DIMD mode and the TIMD mode are set to “false” and signalled into the bitstream, while the usage flag of the TMP mode is set to “true” and signalled into the bitstream.

In a case that there is a minimum one among cost4, . . . , costN, the current CU uses other prediction modes. The usage flags of the DIMD mode, the TIMD mode and the TMP mode are set to “false” and signalled into the bitstream, and a usage flag of a prediction mode corresponding to the minimum rate distortion cost value is set to “true” and signalled into the bitstream. The specific case is not elaborated.

In another specific embodiment, assuming that the first intra prediction mode is the TIMD mode, that the second intra prediction mode is the DIMD mode and that the third intra prediction mode is the TMP mode, the first mode permission identification information may be represented by sps_timd_enable_flag, the second mode permission identification information may be represented by sps_dimd_enable_flag, and the third mode permission identification information may be represented by sps_tmp_enable_flag.

In the encoder, the current block is the current CU. The encoder may traverse the multiple candidate prediction modes first. If the current CU is in an intra mode, the usage permission flags of the TIMD mode, the DIMD mode and the TMP mode are obtained. These flags are sequence level flags and indicate whether the encoder is allowed to use the TIMD mode, the DIMD mode and the TMP mode currently. If all the usage permission flags of the TIMD mode, the DIMD mode and the TMP mode are true, it means that the encoder is allowed to use the TIMD mode, the DIMD mode and the TMP mode.

Specifically, if all the usage permission flags of the TIMD mode, the DIMD mode and the TMP mode are true, the TIMD mode is tried first. Prediction mode information of the current CU is derived. The prediction block of the current CU is determined according to the prediction mode information. The residual block is obtained. The transform and quantization processes are performed, and the first rate distortion cost value corresponding thereto is calculated and recorded as cost1. The DIMD mode is continued to be tried. Prediction mode information of the current CU is derived. The prediction block of the current CU is generated according to the prediction mode information. The residual block is obtained. The transform and quantization processes are performed, and the second rate distortion cost value corresponding thereto is calculated and recorded as cost2. The TMP mode is continued to be tried. An L-shaped region best matching the current CU is searched. A prediction block corresponding thereto is determined. The residual block is obtained. The transform and quantization processes are performed, and the third rate distortion cost value corresponding thereto is calculated and recorded as cost3. Other prediction modes are continued to be tried, and the rate distortion cost values thereof are obtained through corresponding methods and recorded as cost4, . . . , costN. Here, the foregoing other prediction modes are not limited, and may include, but are not limited to, the MIP mode, the normal prediction mode, and the like.

If the cost1 is minimum, the current CU uses the TIMD mode, and the usage flag of the TIMD mode is set to “true” and signalled into the bitstream.

If the cost2 is minimum, the current CU uses the DIMD mode. The usage flag of the TIMD mode is set to “false” and signalled into the bitstream, and the usage flag of the DIMD mode is set to “true” and signalled into the bitstream.

If the cost3 is minimum, the current CU uses the TMP mode. The usage flags of both the TIMD mode and the DIMD mode are set to “false” and signalled into the bitstream, and the usage flag of the TMP mode is set to “true” and signalled into the bitstream.

In a case that there is a minimum one among cost4, . . . , costN, the current CU uses other prediction modes. All the usage flags of the TIMD mode, the DIMD mode and the TMP mode are set to “false” and signalled into the bitstream, and a usage flag of a prediction mode corresponding to the minimum rate distortion cost value is set to “true” and signalled into the bitstream. The specific case is not elaborated.

In the embodiments of the disclosure, with respect to the four intra prediction modes, i.e., the DIMD mode, the TIMD mode, the TMP mode and the MIP mode, the embodiments of the disclosure may also effectively couple relationships and orders among various modes, so that not only compression efficiencies of video encoding and decoding standard technologies may be improved, but also energy consumption and overhead of software and hardware may be reduced.

Specifically, in the encoder, assuming that the multiple candidate prediction modes at least include a first intra prediction mode, a second intra prediction mode, a third intra prediction mode and a fourth intra prediction mode (such as the TMP mode, the TIMD mode, the DIMD mode and the MIP mode, etc.), the encoder needs to determine whether the current block uses the intra prediction mode or the inter prediction mode first. When the intra prediction mode is used, it is also necessary to determine whether the current block is allowed to use the first intra prediction mode, the second intra prediction mode, the third intra prediction mode and the fourth intra prediction mode. Therefore, in some embodiments, the method may further include the following operations.

In a case that the current block uses the intra prediction mode, whether the current block is allowed to use the first intra prediction mode, whether the current block is allowed to use the second intra prediction mode, whether the current block is allowed to use the third intra prediction mode and whether the current block is allowed to use the fourth intra prediction mode are determined.

In a case that the current block is allowed to use the first intra prediction mode, that the current block is allowed to use the second intra prediction mode, that the current block is allowed to use the third intra prediction mode and that the current block is allowed to use the fourth intra prediction mode, the operation of precoding the current block by using the multiple candidate prediction modes to determine the prediction blocks corresponding to the multiple candidate prediction modes respectively is performed.

Further, in some embodiments, the method may further include the following operations.

If it is determined that the current block is allowed to use the fourth intra prediction mode, a value of fourth mode permission identification information is set to a first value.

If it is determined that the current block is not allowed to use the fourth intra prediction mode, the value of the fourth mode permission identification information is set to a second value.

In this case, the method may further include the following operations. The value of the fourth mode permission identification information is encoded, and encoded bits are signalled into a bitstream.

It should be noted that the first value is different from the second value. Taking the fourth mode permission identification information being a flag as an example, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, the first value is equal to 1 and the second value is equal to 0, which would not be limited.

Further, with regard to whether the encoder selects the first intra prediction mode, or the second intra prediction mode, or the third intra prediction mode, or the fourth intra prediction mode, or even remaining intra prediction modes (such as the normal prediction mode) except the first intra prediction mode, the second intra prediction mode, the third intra prediction mode and the fourth intra prediction mode, in some embodiments, the operation of precoding the current block by using the multiple candidate prediction modes to determine the prediction blocks corresponding to the multiple candidate prediction modes respectively may further include the following operations.

The current block is precoded by using the first intra prediction mode to determine a first rate distortion cost value.

The current block is precoded by using the second intra prediction mode to determine a second rate distortion cost value.

The current block is precoded by using the third intra prediction mode to determine a third rate distortion cost value.

The current block is precoded by using the fourth intra prediction mode to determine a fourth rate distortion cost value.

The current block is precoded by using the remaining intra prediction modes except the first intra prediction mode, the second intra prediction mode, the third intra prediction mode and the fourth intra prediction mode to determine a fifth rate distortion cost value.

Accordingly, the operation of determining the target prediction mode of the current block from the multiple candidate prediction modes may include the following operations.

If the first rate distortion cost value is less than any one of the second rate distortion cost value, the third rate distortion cost value, the fourth rate distortion cost value and the fifth rate distortion cost value, the first intra prediction mode is determined as the target prediction mode of the current block.

If the second rate distortion cost value is less than any one of the first rate distortion cost value, the third rate distortion cost value, the fourth rate distortion cost value and the fifth rate distortion cost value, the second intra prediction mode is determined as the target prediction mode of the current block.

If the third rate distortion cost value is less than any one of the first rate distortion cost value, the second rate distortion cost value, the fourth rate distortion cost value and the fifth rate distortion cost value, the third intra prediction mode is determined as the target prediction mode of the current block.

If the fourth rate distortion cost value is less than any one of the first rate distortion cost value, the second rate distortion cost value, the third rate distortion cost value and the fifth rate distortion cost value, the fourth intra prediction mode is determined as the target prediction mode of the current block.

That is, if the first rate distortion cost value corresponding to the first intra prediction mode is minimum, the first intra prediction mode may be determined as the target prediction mode of the current block. If the second rate distortion cost value corresponding to the second intra prediction mode is minimum, the second intra prediction mode may be determined as the target prediction mode of the current block. If the third rate distortion cost value corresponding to the third intra prediction mode is minimum, the third intra prediction mode may be determined as the target prediction mode of the current block. If the fourth rate distortion cost value corresponding to the fourth intra prediction mode is minimum, the fourth intra prediction mode may be determined as the target prediction mode of the current block. If there is a minimum rate distortion cost value in the remaining intra prediction modes, an intra prediction mode corresponding to the minimum rate distortion cost value may be determined as the target prediction mode of the current block.

Further, in some embodiments, the method may further include the following operations.

If it is determined that the current block is predicted by using the fourth intra prediction mode, a value of fourth mode usage identification information is set to a first value.

If it is determined that the current block is not predicted by using the fourth intra prediction mode, the value of the fourth mode usage identification information is set to a second value.

In this case, the method may further include the following operations. The value of the fourth mode usage identification information is encoded, and encoded bits are signalled into a bitstream.

It should be noted that the first value is different from the second value. Taking the fourth mode usage identification information being a flag as an example, with regard to the first value and the second value, the first value may be set to 1, and the second value may be set to 0. Alternatively, the first value may also be set to “true”, and the second value may also be set to “false”. Alternatively, the first value may also be set to 0, and the second value may also be set to 1. Alternatively, the first value may also be set to “false”, and the second value may also be set to “true”. Exemplarily, the first value is equal to 1 and the second value is equal to 0, which would not be limited.

It should also be noted that with regard to the first intra prediction mode, the second intra prediction mode, the third intra prediction mode and the fourth intra prediction mode, in a specific example, the first intra prediction mode is a DIMD mode, the second intra prediction mode is a TMP mode, the third intra prediction mode is a MIP mode, and the fourth intra prediction mode is a TIMD mode. Alternatively, in another specific example, the first intra prediction mode is the TMP mode, the second intra prediction mode is the TIMD mode, the third intra prediction mode is the MIP mode, and the fourth intra prediction mode is the DIMD mode. Alternatively, in yet another specific example, the first intra prediction mode is the TIMD mode, the second intra prediction mode is the DIMD mode, the third intra prediction mode is the TMP mode, and the fourth intra prediction mode is the MIP mode, and the like. No limitation is made here.

In a specific embodiment, assuming that the first intra prediction mode is the DIMD mode, that the second intra prediction mode is the TMP mode, that the third intra prediction mode is the MIP mode and that the fourth intra prediction mode is the TIMD mode, the first mode permission identification information may be represented by sps_dimd_enable_flag, the second mode permission identification information may be represented by sps_tmp_enable_flag, the third mode permission identification information may be represented by sps_mip_enable_flag, and the fourth mode permission identification information may be represented by sps_timd_enable_flag.

In the encoder, the current block is the current CU. The encoder may traverse multiple candidate prediction modes first. If the current CU is in an intra mode, the usage permission flags of the DIMD mode, the TMP mode, the MIP mode and the TIMD mode are obtained. These flags are sequence level flags and indicate whether the encoder is allowed to use the DIMD mode, the TMP mode, the MIP mode and the TIMD mode currently. If all the usage permission flags of the DIMD mode, the TMP mode, the MIP mode and the TIMD mode are true, it means that the encoder is allowed to use the DIMD mode, the TMP mode, the MIP mode and the TIMD mode.

Specifically, if all the usage permission flags of the DIMD mode, the TMP mode, the MIP mode and the TIMD mode are true, the DIMD mode is tried first. Prediction mode information of the current CU is derived. The prediction block of the current CU is determined according to the prediction mode information. The residual block is obtained. The transform and quantization processes are performed. The first rate distortion cost value corresponding thereto is calculated and recorded as cost1. The TMP mode is continued to be tried. An L-shaped region best matching the current CU is searched. A prediction block corresponding thereto is determined. The residual block is obtained. The transform and quantization processes are performed, and the second rate distortion cost value corresponding thereto is calculated and recorded as cost2. The MIP mode is continued to be tried. The prediction block of the current CU is determined. The residual block is obtained. The transform and quantization processes are performed, and the third rate distortion cost value corresponding thereto is calculated and recorded as cost3. The TIMD mode is continued to be tried. Prediction mode information of the current CU is derived. The prediction block of the current CU is determined according to the prediction mode information. The residual block is obtained. The transform and quantization processes are performed, and the fourth rate distortion cost value corresponding thereto is calculated and recorded as cost4. Other prediction modes are continued to be tried, and the rate distortion cost values thereof are obtained through corresponding methods and recorded as cost5, . . . , costN. The foregoing other prediction modes are not limited here.

If the cost1 is minimum, the current CU uses the DIMD mode. The usage flag of the DIMD mode is set to “true” and signalled into the bitstream.

If the cost2 is minimum, the current CU uses the TMP mode. The usage flag of the DIMD mode is set to “false” and signalled into the bitstream, and the usage flag of the TMP mode is set to “true” and signalled into the bitstream.

If the cost3 is minimum, the current CU uses the MIP mode. The usage flags of both the DIMD mode and the TMP mode are set to “false” and signalled into the bitstream, and the usage flag of the MIP mode is set to “true” and signalled into the bitstream. An index serial number of the MIP mode is signalled into the bitstream.

If the cost4 is minimum, the current CU uses the TIMD mode. The usage flags of the DIMD mode, the TMP mode and the MIP mode are set to “false” and signalled into the bitstream, and the usage flag of the TIMD mode is set to “true” and signalled into the bitstream.

In a case that there is a minimum one among cost5, . . . , costN, the current CU uses other prediction modes. The usage flags of the DIMD mode, the TMP mode, the MIP mode and the TIMD mode are set to “false” and signalled into the bitstream, and a usage flag of a prediction mode corresponding to the minimum rate distortion cost value is set to “true” and signalled into the bitstream. The specific case is not elaborated.

In this way, according to a respective precoding result (such as the rate distortion cost value) of each of the multiple candidate prediction modes, the target prediction mode of the current block may be determined from the multiple candidate prediction modes.

At S503, the current block is predicted according to the target prediction mode to determine a prediction block of the current block.

It should be noted that after obtaining the target prediction mode of the current block, the current block may be predicted by using the target prediction mode, so that the prediction block of the current block may be determined.

Further, in some embodiments, after determining the prediction block of the current block, the method may further include the following operations.

A residual block of the current block is determined according to the current block and the prediction block.

The residual block is transformed and quantized to obtain a quantization coefficient matrix.

The quantization coefficient matrix is encoded, and encoded bits are signalled into a bitstream.

In a specific embodiment, the operation of determine the residual block of the current block according to the current block and the prediction block may include the following operations. The subtraction process is performed on the current block and the prediction block to obtain the residual block of the current block.

In this way, after obtaining the residual block of the current block, the residual block may be transformed and quantized to obtain the quantization coefficient matrix. The quantization coefficient matrix is encoded and signalled into the bitstream, so that the decoder may determine the residual block of the current block through decoding and reconstruct the reconstructed block of the current block.

In the embodiments of the disclosure, the DIMD mode and the TMP mode are not used in the same CU simultaneously. That is, in the encoder, if the current CU determines to use the DIMD mode, it only needs to write the usage flag of the DIMD mode into the bitstream, and does not need to write the usage flag of the TMP mode into the bitstream any more. In this way, in the decoder, if the usage flag of the DIMD mode is parsed to be true, the usage flag of the TMP mode does not need to be parsed any more. If the usage flag of the DIMD mode is parsed to be false, it is necessary to continue to parse the usage flag of the TMP mode. Similarly, the embodiments of the disclosure may also couple usage cases of the DIMD mode, the TMP mode, the MIP mode and the TIMD mode. That is, the four modes are mutually exclusive, and a case where two or more modes are used simultaneously does not exist. Therefore, the embodiments of the disclosure provide several corresponding bitstream signalling cases.

The embodiment of the disclosure provides an encoding method. In the encoding method, a current block is precoded by using multiple candidate prediction modes to determine prediction blocks corresponding to the multiple candidate prediction modes respectively. A target prediction mode of the current block is determined from the multiple candidate prediction modes based on the prediction blocks corresponding to the multiple candidate prediction modes. The current block is predicted according to the target prediction mode to determine a prediction block of the current block. In this way, since it is impossible for the same current block to use two intra prediction modes simultaneously, when it is determined that the current block uses the first intra prediction mode, it is no longer necessary to determine the second mode usage identification information by decoding later, so that not only the compression efficiency can be improved, but also the energy consumption and overhead of software and hardware can be reduced, thereby improving decoding performance.

In yet another embodiment of the disclosure, the embodiment of the disclosure further provides a bitstream, and the bitstream is generated by bit encoding according to information to be encoded. The information to be encoded includes at least one of a value of type identification information, a value of first mode permission identification information, a value of second mode permission identification information, a value of third mode permission identification information, a value of fourth mode permission identification information, a value of first mode usage identification information, a value of second mode usage identification information, a value of third mode usage identification information, a value of fourth mode usage identification information, or a quantization coefficient matrix.

In the embodiment of the disclosure, the type identification information is configured to indicate whether a current block uses an intra prediction mode. The first mode permission identification information is configured to indicate whether the current block is allowed to use a first intra prediction mode. The second mode permission identification information is configured to indicate whether the current block is allowed to use a second intra prediction mode. The third mode permission identification information is configured to indicate whether the current block is allowed to use a third intra prediction mode. The fourth mode permission identification information is configured to indicate whether the current block is allowed to use a fourth intra prediction mode. The first mode usage identification information is configured to indicate whether the current block is predicted by using the first intra prediction mode. The second mode usage identification information is configured to indicate whether the current block is predicted by using the second intra prediction mode. The third mode usage identification information is configured to indicate whether the current block is predicted by using the third intra prediction mode. The fourth mode usage identification information is configured to indicate whether the current block is predicted by using the fourth intra prediction mode.

In yet another embodiment of the disclosure, based on the same inventive concept as the foregoing embodiments, with reference to FIG. 6, a diagram of a compositional structure of an encoder 60 provided in an embodiment of the disclosure is shown. As shown in FIG. 6, the encoder 60 includes a precoding unit 601, a first determination unit 602, and a first prediction unit 603.

The precoding unit 601 is configured to precode a current block by using multiple candidate prediction modes to determine prediction blocks corresponding to the multiple candidate prediction modes respectively.

The first determination unit 602 is configured to determine, based on the prediction blocks corresponding to the multiple candidate prediction modes, a target prediction mode of the current block from the multiple candidate prediction modes.

The first prediction unit 603 is configured to predict the current block according to the target prediction mode to determine a prediction block of the current block.

In some embodiments, the first determination unit 602 is specifically configured to: determine rate distortion cost values corresponding to the multiple candidate prediction modes respectively based on the prediction blocks corresponding to the multiple candidate prediction modes, select a minimum rate distortion cost value from the rate distortion cost values corresponding to the multiple candidate prediction modes, and determine a candidate prediction mode corresponding to the minimum rate distortion cost value as the target prediction mode of the current block.

In some embodiments, the first determination unit 602 is further configured to: determine whether the current block is allowed to use a first intra prediction mode and whether the current block is allowed to use a second intra prediction mode in a case that the current block uses an intra prediction mode, and perform the operation of precoding the current block by using the multiple candidate prediction modes to determine the prediction blocks corresponding to the multiple candidate prediction modes respectively in a case that the current block is allowed to use the first intra prediction mode and the current block is allowed to use the second intra prediction mode.

In some embodiments, with reference to FIG. 6, the encoder 60 may further include a setting unit 604 and a writing unit 605.

The setting unit 604 is configured to: set a value of type identification information to a first value if it is determined that the current block uses the intra prediction mode, and set the value of the type identification information to a second value if it is determined that the current block does not use the intra prediction mode.

The writing unit 605 is configured to encode the value of the type identification information and signal encoded bits into a bitstream.

In some embodiments, the setting unit 604 is further configured to: set a value of first mode permission identification information to a first value, if it is determined that the current block is allowed to use the first intra prediction mode, and set the value of the first mode permission identification information to a second value, if it is determined that the current block is not allowed to use the first intra prediction mode.

The writing unit 605 is further configured to encode the value of the first mode permission identification information and signal encoded bits into a bitstream.

In some embodiments, the setting unit 604 is further configured to: set a value of second mode permission identification information to a first value if it is determined that the current block is allowed to use the second intra prediction mode, and set the value of the second mode permission identification information to a second value if it is determined that the current block is not allowed to use the second intra prediction mode.

The writing unit 605 is further configured to encode the value of the second mode permission identification information and signal encoded bits into a bitstream.

In some embodiments, the precoding unit 601 is further configured to: precode the current block by using the first intra prediction mode to determine a first rate distortion cost value, precode the current block by using the second intra prediction mode to determine a second rate distortion cost value, and precode the current block by using remaining intra prediction modes except the first intra prediction mode and the second intra prediction mode to determine a third rate distortion cost value.

In some embodiments, the first determination unit 602 is further configured to: determine the first intra prediction mode as the target prediction mode of the current block if the first rate distortion cost value is less than any one of the second rate distortion cost value and the third rate distortion cost value, and determine the second intra prediction mode as the target prediction mode of the current block if the second rate distortion cost value is less than any one of the first rate distortion cost value and the third rate distortion cost value.

In some embodiments, the setting unit 604 is further configured to: set a value of first mode usage identification information to a first value if it is determined that the current block is predicted by using the first intra prediction mode, and set the value of the first mode usage identification information to a second value if it is determined that the current block is not predicted by using the first intra prediction mode.

The writing unit 605 is further configured to encode the value of the first mode usage identification information and signal encoded bits into a bitstream.

In some embodiments, the setting unit 604 is further configured to: set a value of second mode usage identification information to a first value if it is determined that the current block is predicted by using the second intra prediction mode, and set the value of the second mode usage identification information to a second value if it is determined that the current block is not predicted by using the second intra prediction mode.

The writing unit 605 is further configured to encode the value of the second mode usage identification information, and signal encoded bits into a bitstream.

In some embodiments, the first intra prediction mode is a DIMD mode, and the second intra prediction mode is a TMP mode. Alternatively, the first intra prediction mode is the TMP mode, and the second intra prediction mode is the DIMD mode.

In some embodiments, the first determination unit 602 is further configured to: determine whether the current block is allowed to use a first intra prediction mode, whether the current block is allowed to use a second intra prediction mode and whether the current block is allowed to use a third intra prediction mode in a case that the current block uses an intra prediction mode, and perform the operation of precoding the current block by using the multiple candidate prediction modes to determine the prediction blocks corresponding to the multiple candidate prediction modes respectively in a case that the current block is allowed to use the first intra prediction mode, the current block is allowed to use the second intra prediction mode and the current block is allowed to use the third intra prediction mode.

In some embodiments, the setting unit 604 is further configured to: set a value of third mode permission identification information to a first value if it is determined that the current block is allowed to use the third intra prediction mode, and set the value of the third mode permission identification information to a second value if it is determined that the current block is not allowed to use the third intra prediction mode.

The writing unit 605 is further configured to encode the value of the third mode permission identification information, and signal encoded bits into a bitstream.

In some embodiments, the precoding unit 601 is further configured to: precode the current block by using the first intra prediction mode to determine a first rate distortion cost value, precode the current block by using the second intra prediction mode to determine a second rate distortion cost value, precode the current block by using the third intra prediction mode to determine a third rate distortion cost value, and precode the current block by using remaining intra prediction modes except the first intra prediction mode, the second intra prediction mode and the third intra prediction mode to determine a fourth rate distortion cost value.

In some embodiments, the first determination unit 602 is further configured to: determine the first intra prediction mode as the target prediction mode of the current block if the first rate distortion cost value is less than any one of the second rate distortion cost value, the third rate distortion cost value and the fourth rate distortion cost value, determine the second intra prediction mode as the target prediction mode of the current block if the second rate distortion cost value is less than any one of the first rate distortion cost value, the third rate distortion cost value and the fourth rate distortion cost value; and determine the third intra prediction mode as the target prediction mode of the current block if the third rate distortion cost value is less than any one of the first rate distortion cost value, the second rate distortion cost value and the fourth rate distortion cost value.

In some embodiments, the setting unit 604 is further configured to: set a value of third mode usage identification information to a first value if it is determined that the current block is predicted by using the third intra prediction mode, and set the value of the third mode usage identification information to a second value if it is determined that the current block is not predicted by using the third intra prediction mode.

The writing unit 605 is further configured to encode the value of the third mode usage identification information, and signal encoded bits into a bitstream.

In some embodiments, the first intra prediction mode is a DIMD mode; the second intra prediction mode is a TIMD mode, and the third intra prediction mode is a TMP mode. Alternatively, the first intra prediction mode is the TIMD mode, the second intra prediction mode is the DIMD mode, and the third intra prediction mode is the TMP mode.

In some embodiments, the first determination unit 602 is further configured to: determine whether the current block is allowed to use a first intra prediction mode, whether the current block is allowed to use a second intra prediction mode, whether the current block is allowed to use a third intra prediction mode and whether the current block is allowed to use a fourth intra prediction mode in a case that the current block uses an intra prediction mode, and perform the operation of precoding the current block by using the multiple candidate prediction modes to determine the prediction blocks corresponding to the multiple candidate prediction modes respectively in a case that the current block is allowed to use the first intra prediction mode, the current block is allowed to use the second intra prediction mode, the current block is allowed to use the third intra prediction mode and the current block is allowed to use the fourth intra prediction mode.

In some embodiments, the setting unit 604 is further configured to: set a value of fourth mode permission identification information to a first value if it is determined that the current block is allowed to use the fourth intra prediction mode, and set the value of the fourth mode permission identification information to a second value if it is determined that the current block is not allowed to use the fourth intra prediction mode.

The writing unit 605 is further configured to encode the value of the fourth mode permission identification information and signal encoded bits into a bitstream.

In some embodiments, the precoding unit 601 is further configured to: precode the current block by using the first intra prediction mode to determine a first rate distortion cost value, precode the current block by using the second intra prediction mode to determine a second rate distortion cost value, precode the current block by using the third intra prediction mode to determine a third rate distortion cost value, precode the current block by using the fourth intra prediction mode to determine a fourth rate distortion cost value, and precode the current block by using remaining intra prediction modes except the first intra prediction mode, the second intra prediction mode, the third intra prediction mode and the fourth intra prediction mode to determine a fifth rate distortion cost value.

In some embodiments, the first determination unit 602 is further configured to: determine the first intra prediction mode as the target prediction mode of the current block if the first rate distortion cost value is less than any one of the second rate distortion cost value, the third rate distortion cost value, the fourth rate distortion cost value and the fifth rate distortion cost value, determine the second intra prediction mode as the target prediction mode of the current block if the second rate distortion cost value is less than any one of the first rate distortion cost value, the third rate distortion cost value, the fourth rate distortion cost value and the fifth rate distortion cost value, determine the third intra prediction mode as the target prediction mode of the current block if the third rate distortion cost value is less than any one of the first rate distortion cost value, the second rate distortion cost value, the fourth rate distortion cost value and the fifth rate distortion cost value, and determine the fourth intra prediction mode as the target prediction mode of the current block if the fourth rate distortion cost value is less than any one of the first rate distortion cost value, the second rate distortion cost value, the third rate distortion cost value and the fifth rate distortion cost value.

In some embodiments, the setting unit 604 is further configured to: set a value of fourth mode usage identification information to a first value if it is determined that the current block is predicted by using the fourth intra prediction mode, and set the value of the fourth mode usage identification information to a second value if it is determined that the current block is not predicted by using the fourth intra prediction mode.

The writing unit 605 is further configured to encode the value of the fourth mode usage identification information and signal encoded bits into a bitstream.

In some embodiments, the first intra prediction mode is a DIMD mode, the second intra prediction mode is a TMP mode, the third intra prediction mode is a MIP mode, and the fourth intra prediction mode is a TIMD mode. Alternatively, the first intra prediction mode is the TMP mode, the second intra prediction mode is the TIMD mode, the third intra prediction mode is the MIP mode, and the fourth intra prediction mode is the DIMD mode. Alternatively, the first intra prediction mode is the TIMD mode, the second intra prediction mode is the DIMD mode, the third intra prediction mode is the TMP mode, and the fourth intra prediction mode is the MIP mode.

In some embodiments, the first determination unit 602 is further configured to: determine a residual block of the current block according to the current block and the prediction block, and transform and quantize the residual block to obtain a quantization coefficient matrix.

The writing unit 605 is further configured to encode the quantization coefficient matrix, and signal encoded bits into a bitstream.

It may be understood that in the embodiment of the disclosure, “unit” may be a part of a circuit, a part of a processor, a part of a program or software, etc. Of course, “unit” may also be a module, or may be non-modular. Furthermore, components in the embodiment may be integrated into a processing unit, or each unit may physically exist alone, or two or more units may be integrated into a unit. The integrated unit may be implemented in form of hardware, or may be implemented in form of a software function module.

When the integrated unit is implemented in form of the software function module rather than sold or used as an independent product, the integrated unit may be stored in a computer-readable storage medium. Based on such understanding, the technical solution of the embodiment substantially or parts making contributions to the related art, or all or part of the technical solution may be embodied in form of a software product. The computer software product may be stored in a storage medium and ma include several instructions to enable a computer device (which may be a personal computer, a server, a network device, etc.) or a processor to execute all or part of operations of the method described in the embodiment. The foregoing storage medium may include various media capable of storing program codes, such as a U disk, a mobile hard disk, a Read Only Memory (ROM), a Random Access Memory (RAM), a magnetic disk, or an optical disk, etc.

Therefore, an embodiment of the disclosure provides a computer storage medium, applied to the encoder 60. The computer storage medium stores a computer program, and the computer program implements the method of any one of the foregoing embodiments when being executed by a first processor.

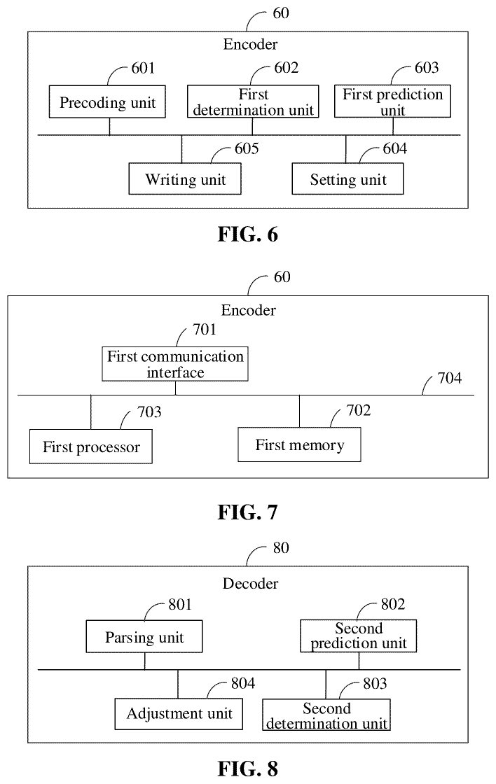

Based on the composition of the encoder 60 and the computer storage medium, with reference to FIG. 7, a structural diagram of specific hardware of an encoder 60 provided in an embodiment of the disclosure is shown. As shown in FIG. 7, the specific hardware of the encoder may include a first communication interface 701, a first memory 702, and a first processor 703, various components are coupled together by a first bus system 704. It may be understood that the first bus system 704 is configured to implement connection and communication between these components. Besides a data bus, the first bus system 704 includes a power bus, a control bus, and a state signal bus. However, various buses are marked as the first bus system 704 in FIG. 7 for clarity of illustration.

The first communication interface 701 is configured to receive and transmit signals in a process of receiving and transmitting information between the encoder and other external network elements.

The first memory 702 is configured to store a computer program executable on the first processor 703.

The first processor 703 is configured to perform the following operations when executing the computer program:
precoding a current block by using multiple candidate prediction modes to determine prediction blocks corresponding to the multiple candidate prediction modes respectively;
determining a target prediction mode of the current block from the multiple candidate prediction modes based on the prediction blocks corresponding to the multiple candidate prediction modes; and
predicting the current block according to the target prediction mode to determine a prediction block of the current block.

It may be understood that the first memory 702 in the embodiment of the disclosure may be a volatile memory or a non-volatile memory, or may include both volatile and non-volatile memories. The non-volatile memory may be a ROM, a Programmable ROM (PROM), an Erasable PROM (EPROM), an Electrically EPROM (EEPROM) or a flash memory. The volatile memory may be a RAM which is used as an external cache. By way of exemplary rather than restrictive descriptions, many forms of RAMs are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM) and a Direct Rambus RAM (DRRAM). The first memory 702 of the systems and methods described in the disclosure is intended to include, but is not limited to these and any other suitable type of memories.

Furthermore, the first processor 703 may be an integrated circuit chip with signal processing capability. During implementation, operations of the foregoing methods may be completed by an integrated logical circuit in a hardware form in the first processor 703 or instructions in a software form. The first processor 703 may be a general-purpose processor, a Digital Signal Processor (DSP), an Application Specific Integrated Circuit (ASIC), a Field Programmable Gate Array (FPGA), or other programmable logic devices, discrete gates or transistor logic devices, discrete hardware components. The methods, operations and logical block diagrams disclosed in the embodiments of the disclosure may be implemented or performed. The general-purpose processor may be a microprocessor, or the processor may be any conventional processor, etc. Operations of the methods disclosed in combination with the embodiments of the disclosure may be directly embodied as being executed and completed by a hardware decoding processor, or executed and completed by a combination of hardware in the decoding processor and software modules. The software module may be located in a mature storage medium in the art, such as a RAM, a flash memory, a ROM, a PROM, an EEPROM, a register, etc. The storage medium is located in the first memory 702, and the first processor 703 reads information in the first memory 702, and completes operations of the above methods in combination with the hardware thereof.

It may be understood that these embodiments described in the disclosure may be implemented by hardware, software, firmware, middleware, microcode, or a combination thereof. With regard to implementation based on hardware, the processing unit may be implemented in one or more ASICs, DSPs, DSP Devices (DSPDs), Programmable Logic Devices (PLDs), FPGAs, general-purpose processors, controllers, microcontrollers, microprocessors, other electronic units configured to perform the functions described in the disclosure, or a combination thereof. With regard to implementation based on software, technologies described in the disclosure may be implemented by modules (such as processes, functions, etc.) performing the functions described in the disclosure. Software codes may be stored in the memory and executed by the processor. The memory may be implemented in the processor or outside the processor.

Optionally, in another embodiment, the first processor 703 is further configured to perform the method of any one of the foregoing embodiments when executing the computer program.

The embodiment provides an encoder which may include a precoding unit, a first determination unit and a first prediction unit. In this way, since it is impossible for the same current block to use two intra prediction modes simultaneously, when it is determined that the current block uses the first intra prediction mode, it is no longer necessary to determine the second mode usage identification information by decoding later, so that not only the compression efficiency can be improved, but also the energy consumption and overhead of software and hardware can be reduced, thereby improving decoding performance.

In yet another embodiment of the disclosure, based on the same inventive concept as the foregoing embodiments, with reference to FIG. 8, a diagram of a compositional structure of a decoder 80 provided in an embodiment of the disclosure is shown. As shown in FIG. 8, the decoder 80 includes a parsing unit 801 and a second prediction unit 802.

The parsing unit 801 is configured to parse a bitstream to determine first mode usage identification information of a current block.

The second prediction unit 802 is configured to predict the current block according to a first intra prediction mode to determine a prediction block of the current block if the first mode usage identification information indicates that the current block uses the first intra prediction mode.

The second prediction unit 802 is further configured to parse the bitstream to determine second mode usage identification information of the current block if the first mode usage identification information indicates that the current block does not use the first intra prediction mode, and determine a target prediction mode of the current block according to the second mode usage identification information, and predict the current block according to the target prediction mode to determine the prediction block of the current block.

In some embodiments, the parsing unit 801 is further configured to: parse the bitstream to determine type identification information, parse the bitstream to determine first mode permission identification information and second mode permission identification information of the current block if the type identification information indicates that the current block uses an intra prediction mode, and perform the operation of parsing the bitstream to determine the first mode usage identification information of the current block in a case that the first mode permission identification information indicates that the current block is allowed to use the first intra prediction mode and the second mode permission identification information indicates that the current block is allowed to use a second intra prediction mode.

In some embodiments, with reference to FIG. 8, the decoder 80 may further include a second determination unit 803 which is configured to: determine that the first mode permission identification information indicates that the current block is allowed to use the first intra prediction mode if a value of the first mode permission identification information is a first value, and determine that the first mode permission identification information indicates that the current block is not allowed to use the first intra prediction mode if the value of the first mode permission identification information is a second value.

In some embodiments, the second determination unit 803 is further configured to: determine that the second mode permission identification information indicates that the current block is allowed to use the second intra prediction mode if a value of the second mode permission identification information is a first value, and determine that the second mode permission identification information indicates that the current block is not allowed to use the second intra prediction mode if the value of the second mode permission identification information is a second value.

In some embodiments, the second determination unit 803 is further configured to: determine that the first mode usage identification information indicates that the current block uses the first intra prediction mode if a value of the first mode usage identification information is a first value, and determine that the first mode usage identification information indicates that the current block does not use the first intra prediction mode if the value of the first mode usage identification information is a second value.

In some embodiments, the second determination unit 803 is further configured to: set an initial parsing order of the current block, and determine the first intra prediction mode and the second intra prediction mode according to the initial parsing order. The initial parsing order at least includes one of: a DIMD mode and a TMP mode; or the TMP mode and the DIMD mode.

In some embodiments, with reference to FIG. 8, the decoder 80 may further include an adjustment unit 804.

The second determination unit 803 is further configured to determine auxiliary adjustment information of the current block. The auxiliary adjustment information includes at least one of block size information or frame type information.

The adjustment unit 804 is configured to: adjust the initial parsing order according to the auxiliary adjustment information of the current block to obtain an adjusted parsing order, and determine the first intra prediction mode and the second intra prediction mode according to the adjusted parsing order.

In some embodiments, the second prediction unit 802 is further configured to: determine a second intra prediction mode as the target prediction mode of the current block if the second mode usage identification information indicates that the current block uses the second intra prediction mode, parse the bitstream to determine third mode usage identification information of the current block if the second mode usage identification information indicates that the current block does not use the second intra prediction mode, and determine the target prediction mode of the current block according to the third mode usage identification information.

In some embodiments, the second determination unit 803 is further configured to: determine that the second mode usage identification information indicates that the current block uses the second intra prediction mode if a value of the second mode usage identification information is a first value, and determine that the second mode usage identification information indicates that the current block does not use the first intra prediction mode if the value of the second mode usage identification information is a second value.

In some embodiments, the parsing unit 801 is further configured to: parse the bitstream to determine type identification information, parse the bitstream to determine first mode permission identification information, second mode permission identification information and third mode permission identification information of the current block if the type identification information indicates that the current block uses an intra prediction mode, and parse the bitstream to determine the first mode usage identification information of the current block in a case that the first mode permission identification information indicates that the current block is allowed to use the first intra prediction mode, the second mode permission identification information indicates that the current block is allowed to use the second intra prediction mode, and the third mode permission identification information indicates that the current block is allowed to use a third intra prediction mode.

In some embodiments, the second determination unit 803 is further configured to: set an initial parsing order of the current block, and determine the first intra prediction mode, the second intra prediction mode and the third intra prediction mode according to the initial parsing order. The initial parsing order at least includes one of: a DIMD mode, a TIMD mode and a TMP mode; or the TIMD mode, the DIMD mode and the TMP mode.

In some embodiments, the second determination unit 803 is further configured to determine auxiliary adjustment information of the current block. The auxiliary adjustment information includes at least one of block size information or frame type information.

The adjustment unit 804 is configured to: adjust the initial parsing order according to the auxiliary adjustment information of the current block to obtain an adjusted parsing order, and determine the first intra prediction mode, the second intra prediction mode and the third intra prediction mode according to the adjusted parsing order.

In some embodiments, the second prediction unit 802 is further configured to: determine a third intra prediction mode as the target prediction mode of the current block if the third mode usage identification information indicates that the current block uses the third intra prediction mode, parse the bitstream to determine fourth mode usage identification information of the current block if the third mode usage identification information indicates that the current block does not use the third intra prediction mode, and determine the target prediction mode of the current block according to the fourth mode usage identification information.

In some embodiments, the second determination unit 803 is further configured to: determine that the third mode usage identification information indicates that the current block uses the third intra prediction mode if a value of the third mode usage identification information is a first value, and determine that the third mode usage identification information indicates that the current block does not use the third intra prediction mode if the value of the third mode usage identification information is a second value.

In some embodiments, the parsing unit 801 is further configured to: parse the bitstream to determine type identification information, parse the bitstream to determine first mode permission identification information, second mode permission identification information, third mode permission identification information and fourth mode permission identification information of the current block if the type identification information indicates that the current block uses an intra prediction mode, and parse the bitstream to determine the first mode usage identification information of the current block in a case that the first mode permission identification information indicates that the current block is allowed to use the first intra prediction mode, the second mode permission identification information indicates that the current block is allowed to use the second intra prediction mode, the third mode permission identification information indicates that the current block is allowed to use the third intra prediction mode, and the fourth mode permission identification information indicates that the current block is allowed to use a fourth intra prediction mode.

In some embodiments, the second determination unit 803 is further configured to: set an initial parsing order of the current block, and determine the first intra prediction mode, the second intra prediction mode, the third intra prediction mode and the fourth intra prediction mode according to the initial parsing order.

The initial parsing order at least includes one of: a DIMD mode, a TMP mode, a MIP mode and a TIMD mode; the TMP mode, the TIMD mode, the MIP mode and the DIMD mode; or the TIMD mode, the DIMD mode, the TMP mode and the MIP mode.

In some embodiments, the second determination unit 803 is further configured to determine auxiliary adjustment information of the current block. The auxiliary adjustment information includes block size information and/or frame type information.

The adjustment unit 804 is further configured to: adjust the initial parsing order according to the auxiliary adjustment information of the current block to obtain an adjusted parsing order, and determine the first intra prediction mode, the second intra prediction mode, the third intra prediction mode and the fourth intra prediction mode according to the adjusted parsing order.

In some embodiments, the second prediction unit 802 is further configured to: determine a fourth intra prediction mode as the target prediction mode of the current block if the fourth mode usage identification information indicates that the current block uses the fourth intra prediction mode, parse the bitstream to determine fifth mode usage identification information of the current block if the fourth mode usage identification information indicates that the current block does not use the fourth intra prediction mode, and determine the target prediction mode of the current block according to the fifth mode usage identification information. The fifth mode usage identification information is configured to indicate whether the current block uses a fifth intra prediction mode, and the fifth intra prediction mode is a remaining intra prediction mode except the first intra prediction mode, the second intra prediction mode, the third intra prediction mode and the fourth intra prediction mode.

In some embodiments, the parsing unit 801 is further configured to parse the bitstream to determine a quantization coefficient matrix.

The second determination unit 803 is further configured to: perform inverse quantization and inverse transform on the quantization coefficient matrix to obtain a residual block of the current block, and obtain a reconstructed block of the current block according to the prediction block and the residual block.

It may be understood that in the embodiment of the disclosure, “unit” may be a part of a circuit, a part of a processor, a part of a program or software, etc. Of course, “unit” may also be a module, or may be non-modular. Furthermore, components in the embodiment may be integrated into a processing unit, or each unit may physically exist alone, or two or more units may be integrated into a unit. The integrated unit may be implemented in form of hardware, or may be implemented in form of a software function module.

When the integrated unit is implemented in form of the software function module rather than sold or used as an independent product, the integrated unit may be stored in a computer-readable storage medium. Based on such understanding, the embodiment provides a computer storage medium applied to the decoder 80. The computer storage medium stores a computer program, and the computer program implements the method of any one of the foregoing embodiments when being executed by a second processor.

Based on the composition of the decoder 80 and the computer storage medium, with reference to FIG. 9, a structural diagram of specific hardware of a decoder 80 provided in an embodiment of the disclosure is shown. As shown in FIG. 9, the specific hardware of the decoder may include a second communication interface 901, a second memory 902 and a second processor 903. Various components are coupled together by a second bus system 904. It may be understood that the second bus system 904 is configured to implement connection and communication between these components. Besides a data bus, the second bus system 904 includes a power bus, a control bus and a state signal bus. However, various buses are marked as the second bus system 904 in FIG. 9 for clarity of illustration.

The second communication interface 901 is configured to receive and transmit signals in a process of receiving and transmitting information between the decoder and other external network elements.

The second memory 902 is configured to store a computer program executable on the second processor 903.

The second processor 903 is configured to perform the following operations when executing the computer program:

parsing a bitstream to determine first mode usage identification information of a current block;

predicting the current block according to a first intra prediction mode to determine a prediction block of the current block if the first mode usage identification information indicates that the current block uses the first intra prediction mode; and

parsing the bitstream to determine second mode usage identification information of the current block if the first mode usage identification information indicates that the current block does not use the first intra prediction mode, determining a target prediction mode of the current block according to the second mode usage identification information, and predicting the current block according to the target prediction mode to determine the prediction block of the current block.

Optionally, in another embodiment, the second processor 903 is further configured to perform the method of any one of the foregoing embodiments when executing the computer program.

It may be understood that hardware functions of the second memory 902 are similar to those of the first memory 702, and hardware functions of the second processor 903 are similar to those of the first processor 703, which are not elaborated here.

The embodiment provides a decoder which may include a parsing unit and a second prediction unit. In this way, since it is impossible for the same current block to use two intra prediction modes simultaneously, when it is obtained by decoding that the current block uses the first intra prediction mode, the second mode usage identification information does not need to be parsed any more, and only when it is obtained by decoding that the current block does not use the first intra prediction mode, the second mode usage identification information needs to be parsed at this time, which may not only improve compression efficiency, but also reduce energy consumption and overhead of software and hardware, thereby improving encoding and decoding performance.

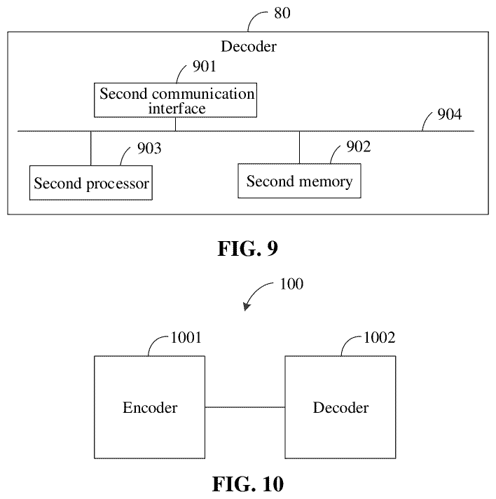

In yet another embodiment of the disclosure, with reference to FIG. 10, a diagram of a compositional structure of an encoding and decoding system provided in an embodiment of the disclosure is shown. As shown in FIG. 10, the encoding and decoding system 100 may include an encoder 1001 and a decoder 1002. The encoder 1001 may be the encoder described in any one of the foregoing embodiments, and the decoder 1002 may be the decoder described in any one of the foregoing embodiments.

In the embodiment of the disclosure, the encoder 1001 may perform bit encoding according to information to be encoded to generate a bitstream, and then transmit the bitstream to the decoder 1002. In this way, the decoder 1002 may obtain, by parsing the bitstream, information such as a value of type identification information signalled in the bitstream, a value of first mode permission identification information, a value of second mode permission identification information, a value of third mode permission identification information, a value of fourth mode permission identification information, a value of first mode usage identification information, a value of second mode usage identification information, a value of third mode usage identification information, a value of fourth mode usage identification information, a quantization coefficient matrix, or the like, so that the decoder 1002 may finally reconstruct a reconstructed block and a reconstructed picture.

It should be noted that in the disclosure, terms “include”, “contain” or any other variants thereof are intended to cover non-exclusive inclusion, so that a process, a method, an article or a device including a series of elements includes not only those elements, but also other elements which are not explicitly listed, or elements inherent to such process, method, article or device. In the absence of more limitations, an element defined by a statement “include a . . . ” does not exclude presence of additional identical elements in the process, method, article or device including the element.

Serial numbers of the embodiments of the disclosure are merely for description, and do not represent advantages and disadvantages of the embodiments.

Methods disclosed in several method embodiments provided in the disclosure may be arbitrarily combined without conflict to obtain a new method embodiment.

Features disclosed in several product embodiments provided in the disclosure may be arbitrarily combined without conflict to obtain a new product embodiment.

Features disclosed in several method or device embodiments provided in the disclosure may be arbitrarily combined without conflict to obtain a new method or device embodiment.

The above descriptions are merely specific implementations of the disclosure. However, the scope of protection of the disclosure is not limited thereto. Any variation or replacement easily conceived by technicians familiar with the technical field within the technical scope disclosed by the disclosure shall fall within the scope of protection of the disclosure. Therefore, the scope of protection of the disclosure shall be subjected to the scope of protection of the claims.

### INDUSTRIAL APPLICABILITY

In the embodiments of the disclosure, at the encoder side, a current block is precoded by using multiple candidate prediction modes to determine prediction blocks corresponding to the multiple candidate prediction modes respectively. A target prediction mode of the current block is determined from the multiple candidate prediction modes based on the prediction blocks corresponding to the multiple candidate prediction modes. The current block is predicted according to the target prediction mode to determine a prediction block of the current block. At the decoder side, a bitstream is parsed to determine first mode usage identification information of the current block. If the first mode usage identification information indicates that the current block uses a first intra prediction mode, the current block is predicted according to the first intra prediction mode to determine a prediction block of the current block. If the first mode usage identification information indicates that the current block does not use the first intra prediction mode, the bitstream is parsed to determine second mode usage identification information of the current block. A target prediction mode of the current block is determined according to the second mode usage identification information, and the current block is predicted according to the target prediction mode to determine the prediction block of the current block. In this way, since it is impossible for the same current block to use two intra prediction modes simultaneously, when it is obtained by decoding that the current block uses the first intra prediction mode, the second mode usage identification information does not need to be parsed any more, and only when it is obtained by decoding that the current block does not use the first intra prediction mode, the second mode usage identification information needs to be parsed at this time, which may not only improve compression efficiency, but also reduce energy consumption and overhead of software and hardware, thereby improving encoding and decoding performance.

1. A decoding method, applied to a decoder, comprising:
parsing a bitstream to determine first mode usage identification information of a current block;
if the first mode usage identification information indicates that the current block uses a first intra prediction mode, predicting the current block according to the first intra prediction mode to determine a prediction block of the current block; and
if the first mode usage identification information indicates that the current block does not use the first intra prediction mode, parsing the bitstream to determine second mode usage identification information of the current block, determining a target prediction mode of the current block according to the second mode usage identification information, and predicting the current block according to the target prediction mode to determine the prediction block of the current block.

2. The method of claim 1, further comprising:
parsing the bitstream to determine type identification information;
if the type identification information indicates that the current block uses an intra prediction mode, parsing the bitstream to determine first mode permission identification information and second mode permission identification information of the current block; and
in a case that the first mode permission identification information indicates that the current block is allowed to use the first intra prediction mode and the second mode permission identification information indicates that the current block is allowed to use a second intra prediction mode, performing the operation of parsing the bitstream to determine the first mode usage identification information of the current block.

3. The method of claim 2, further comprising:
if a value of the first mode permission identification information is a first value, determining that the first mode permission identification information indicates that the current block is allowed to use the first intra prediction mode; and
if the value of the first mode permission identification information is a second value, determining that the first mode permission identification information indicates that the current block is not allowed to use the first intra prediction mode.

4. The method of claim 2, further comprising:
if a value of the second mode permission identification information is a first value, determining that the second mode permission identification information indicates that the current block is allowed to use the second intra prediction mode; and
if the value of the second mode permission identification information is a second value, determining that the second mode permission identification information indicates that the current block is not allowed to use the second intra prediction mode.

5. The method of claim 1, further comprising:
if a value of the first mode usage identification information is a first value, determining that the first mode usage identification information indicates that the current block uses the first intra prediction mode; and
if the value of the first mode usage identification information is a second value, determining that the first mode usage identification information indicates that the current block does not use the first intra prediction mode.

6. The method of claim 1, further comprising:
setting an initial parsing order of the current block; and
determining the first intra prediction mode and the second intra prediction mode according to the initial parsing order,
wherein the initial parsing order at least comprises one of:
an order of a Decoder side Intra Mode Derivation (DIMD) mode and a Template Matching Prediction (TMP) mode; or
an order of the TMP mode and the DIMD mode.

7. The method of claim 6, further comprising:
determining auxiliary adjustment information of the current block, wherein the auxiliary adjustment information comprises at least one of block size information or frame type information;
adjusting the initial parsing order according to the auxiliary adjustment information of the current block to obtain an adjusted parsing order; and
determining the first intra prediction mode and the second intra prediction mode according to the adjusted parsing order.

8. The method of claim 1, wherein determining the target prediction mode of the current block according to the second mode usage identification information comprises:
if the second mode usage identification information indicates that the current block uses a second intra prediction mode, determining the second intra prediction mode as the target prediction mode of the current block; and
if the second mode usage identification information indicates that the current block does not use the second intra prediction mode, parsing the bitstream to determine third mode usage identification information of the current block, and determining the target prediction mode of the current block according to the third mode usage identification information.

9. The method of claim 8, further comprising:
if a value of the second mode usage identification information is a first value, determining that the second mode usage identification information indicates that the current block uses the second intra prediction mode; and
if the value of the second mode usage identification information is a second value, determining that the second mode usage identification information indicates that the current block does not use the second intra prediction mode.

10. The method of claim 8, wherein parsing the bitstream to determine the first mode usage identification information of the current block comprises:
parsing the bitstream to determine type identification information;
if the type identification information indicates that the current block uses an intra prediction mode, parsing the bitstream to determine first mode permission identification information, second mode permission identification information and third mode permission identification information of the current block; and
in a case that the first mode permission identification information indicates that the current block is allowed to use the first intra prediction mode, the second mode permission identification information indicates that the current block is allowed to use the second intra prediction mode, and the third mode permission identification information indicates that the current block is allowed to use a third intra prediction mode, performing the operation of parsing the bitstream to determine the first mode usage identification information of the current block.

11. The method of claim 10, further comprising:
setting an initial parsing order of the current block; and
determining the first intra prediction mode, the second intra prediction mode and the third intra prediction mode according to the initial parsing order,
wherein the initial parsing order at least comprises one of:
an order of a Decoder side Intra Mode Derivation (DIMD) mode, a Template based Intra Mode Derivation (TIMD) mode and a Template Matching Prediction (TMP) mode; or
an order of the TIMD mode, the DIMD mode and the TMP mode.

12. The method of claim 11, further comprising:
determining auxiliary adjustment information of the current block, wherein the auxiliary adjustment information comprises at least one of block size information or frame type information;
adjusting the initial parsing order according to the auxiliary adjustment information of the current block to obtain an adjusted parsing order; and
determining the first intra prediction mode, the second intra prediction mode and the third intra prediction mode according to the adjusted parsing order.

13. The method of claim 8, wherein determining the target prediction mode of the current block according to the third mode usage identification information comprises:
if the third mode usage identification information indicates that the current block uses a third intra prediction mode, determining the third intra prediction mode as the target prediction mode of the current block; and
if the third mode usage identification information indicates that the current block does not use the third intra prediction mode, parsing the bitstream to determine fourth mode usage identification information of the current block, and determining the target prediction mode of the current block according to the fourth mode usage identification information.

14. The method of claim 13, further comprising:
if a value of the third mode usage identification information is a first value, determining that the third mode usage identification information indicates that the current block uses the third intra prediction mode; and
if the value of the third mode usage identification information is a second value, determining that the third mode usage identification information indicates that the current block does not use the third intra prediction mode.

15. The method of claim 13, wherein parsing the bitstream to determine the first mode usage identification information of the current block comprises:
parsing the bitstream to determine type identification information;
if the type identification information indicates that the current block uses an intra prediction mode, parsing the bitstream to determine first mode permission identification information, second mode permission identification information, third mode permission identification information and fourth mode permission identification information of the current block; and
in a case that the first mode permission identification information indicates that the current block is allowed to use the first intra prediction mode, the second mode permission identification information indicates that the current block is allowed to use the second intra prediction mode, the third mode permission identification information indicates that the current block is allowed to use the third intra prediction mode, and the fourth mode permission identification information indicates that the current block is allowed to use a fourth intra prediction mode, parsing the bitstream to determine the first mode usage identification information of the current block.

16. The method of claim 15, further comprising:
setting an initial parsing order of the current block; and
determining the first intra prediction mode, the second intra prediction mode, the third intra prediction mode and the fourth intra prediction mode according to the initial parsing order,
wherein the initial parsing order at least comprises one of:
an order of a Decoder side Intra Mode Derivation (DIMD) mode, a Template Matching Prediction (TMP) mode, a Matrix based Intra Prediction (MIP) mode and a Template based Intra Mode Derivation (TIMD) mode;
an order of the TMP mode, the TIMD mode, the MIP mode and the DIMD mode; or
an order of the TIMD mode, the DIMD mode, the TMP mode and the MIP mode.

17. The method of claim 1, wherein after determining the prediction block of the current block, the method further comprises:
parsing the bitstream to determine a quantization coefficient matrix;
performing inverse quantization and inverse transform on the quantization coefficient matrix to obtain a residual block of the current block; and
obtaining a reconstructed block of the current block according to the prediction block and the residual block.

18. An encoding method, applied to an encoder, comprising:
precoding a current block by using a plurality of candidate prediction modes to determine prediction blocks corresponding to the plurality of candidate prediction modes respectively;
determining a target prediction mode of the current block from the plurality of candidate prediction modes based on the prediction blocks corresponding to the plurality of candidate prediction modes; and
predicting the current block according to the target prediction mode to determine a prediction block of the current block.

19. An encoder, comprising a memory and a processor,
wherein the memory is configured to store a computer program executable on the first processor, and
the processor is configured to perform the method of claim 18 when executing the computer program.

20. A decoder, comprising a memory and a processor,
wherein the memory is configured to store a computer program executable on the second processor, and
the processor is configured to execute the computer program stored on the memory to:
parse a bitstream to determine first mode usage identification information of a current block;
if the first mode usage identification information indicates that the current block uses a first intra prediction mode, predict the current block according to the first intra prediction mode to determine a prediction block of the current block; and
if the first mode usage identification information indicates that the current block does not use the first intra prediction mode, parse the bitstream to determine second mode usage identification information of the current block, determine a target prediction mode of the current block according to the second mode usage identification information, and predict the current block according to the target prediction mode to determine the prediction block of the current block.
